(19) United States
(12) Patent Application Publication
(10) Pub. No.: US 2008/0316570 A1
(43) Pub. Date: Dec. 25, 2008

(54) OPTICAL MODULATOR MODULE AND TEMPERATURE SENSOR

(75) Inventors: Heung-Woo Park, Suwon-si (KR); Sang-Kyeong Yun, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD, Suwon (KR)

(21) Appl. No.: 12/142,709

(22) Filed: Jun. 19, 2008

(30) Foreign Application Priority Data
Jun. 20, 2007 (KR) 10-2007-0060494
Jun. 20, 2007 (KR) 10-2007-0060592
Aug. 27, 2007 (KR) 10-2007-0086269

(51) Int. Cl. G02F 1/00; G01K 7/16

(52) U.S. Cl. 359/237; 374/185; 374/E07.018

(57) ABSTRACT

Disclosed is an optical modulator module having a micro-heater. The optical modulator module can include an optical modulator, modulating a beam of light emitted from a light source and emitting the modulated beam of light; and a micro-heater, manufactured in the optical modulator. The present invention provides an optical modulator module having a micro-heater and a temperature sensor that can control temperature in order to prevent an error of the operation of an optical modulator caused by the temperature and that can make the operation of an optical modulator stable within a shorter during of time directly after a power is supplied to the optical modulator module.

### CROSS-REFERENCE TO RELATED PATENT APPLICATIONS

This application claims the benefit of Korean Patent Application Nos. 10-2007-0060592, 10-2007-0060494 and 10-2007-86269, filed on Jun. 20, 2007, Jun. 20, 2007 and Aug. 27, 2007, respectively, in the Korean Intellectual Property Office, the disclosure of which is incorporated herein in its entirety by reference.

### BACKGROUND OF THE INVENTION

1. Field of the Invention

The present invention relates to an optical modulator module, more specifically to an optical modulator module including a micro-heater for controlling the temperature of an optical modulator, a cooling unit and a temperature sensor which can perform tuning.

2. Background Art

The optical modulator, which outputs a modulation beam of light having a desired luminance value by reflecting or diffracting an incident beam of light, creates interference by electric-mechanically controlling the position of a micromirror.

In particular, the optical modulator outputs a modulation beam of light by modulating an incident beam of light through the contraction and expansion of a piezoelectric element controlling the position of a micromirror included in the optical modulator. At this time, since the micromirror has temperature fluctuations, the change of temperature becomes one of important factors for the operation of the optical modulator. In other words, it is more important to control the temperature which may have an effect on the contraction and extension of the piezoelectric element for controlling the position of the micromirror in order to output a modulation beam of light through an accurate operation of the optical modulator.

To solve the problem, the conventional art has attempted to control the temperature of the inside of the optical modulator by directly placing a heat sink close to the optical modulator. However, a big size of the heat sink is suitable for a projective display apparatus such as a projection TV but makes it impossible to apply the heat sink to a small-sized apparatus such as a mobile phone. Further, while the heat sink merely prevents the temperature from being suddenly changed by simply allowing heat circulation to be smoothed, the heat sink makes it difficult to control the temperature of the optical modulator to be maintained in a specific range of temperature.

Also, in the case of an optical modulator module, it takes from about 3 minutes at the minimum to about 30 minutes at the maximum to allow an initial power to be supplied and a driving circuit placed in the module to be heated and to reach to a stable status. This shows that an image displayed by using an output beam of light modulated through the optical modulator is under an unstable status for some minutes directly after a power is supplied.

The optical modulator has another problem related to the temperature. In the case of an optical modulator, particularly, a diffractive optical modulator outputting a linear beam of light, it is necessary to make each position of individual micromirrors stable by uniforming the temperature of whole area of the optical modulator in order to output the same quality image.

The unexpected change of temperature of the optical modulator causes each position of the micromirrors to be inconsistently changed. It is very difficult to adjust the positions of the micromirrors in order to correct an error caused by the insistent change.

Also, since the optical modulator module is used for portable electronic equipment (e.g. mobile phones) having various multimedia functions, the temperature of the optical modulator module is likely to be affected by the heat generated by the other elements of the portable electronic equipments.

Conventionally, the temperature sensor measures the temperature by using heat expansion, resistance change according to temperature change, the Peirier effect and magnitude of light. The method using the resistance change according to temperature change makes it possible to measure the pertinent temperature by using a changed resistance as the result of using the resistance change ratio with respect to the change of temperature. The temperature sensor using this method is a resistance temperature detector (RTD) temperature sensor or a thermistor.

The RTD temperature sensor uses the characteristic that electric resistance is increased according to the change of temperature, and the thermistor, which is made of semiconductor, uses the characteristic of a resistance temperature coefficient that if the temperature is increased, the resistance is decreased (NTC or CTR) or increased (PTC).

Since the RTD temperature sensor or the thermistor having large resistance temperature coefficients for temperature make it easy to measure micro-temperature and perform a precise measurement, it is possible to miniaturize the RTD temperature sensor or the thermistor. In particular, the RTD temperature sensor using Pt is considered as one of most popular materials thanks to good accuracy and reproducibility by sensibly reacting to the resistance varied according to the change of temperature.

At this time, in the RTD used for the temperature sensor, the relationship between the resistance and the temperature can be represented by using the following formula 1.

R=R₀[1+α(T−T₀)] [Formula 1]

In the formula 3, R₀ refers to an initial resistance value, and α refers to a resistance temperature coefficient. T refers to a temperature, and To refers to an initial temperature. α is varied according to a metal material. The temperature sensor can measure the temperature by using the relationship between the resistance and the temperature. At this time, since an initial resistance value R₀ is the initial value of the resistance used for the temperature sensor, the R₀ is required to be accurately designed in order to measure the temperature without any error form the following formula 1.

In the case of the conventional initial resistance value of the temperature sensor, there has been an error between a value designed by a manufacturer and a resistance actually manufactured according to the designed value. This is resulted from an error, which is generated in the manufacturing process, caused by the width, length and thickness of the resistance and a nonresistance value. Accordingly, it is necessary to perform the tuning for allowing the temperature sensor to have a desired initial resistance in order to reduce the error.

In accordance with the conventional temperature sensor tuning method, it is possible to manufacture the temperature sensor having the initial resistance closest to the desired initial resistance by dividing into a fixed resistance part and a variable resistance part and by performing the tuning of the variable resistance part by use of a laser. However, the conventional method makes it difficult to apply to a small-sized temperature sensor due to the large width of the laser.

### SUMMARY OF THE INVENTION

Accordingly, the present invention provides an optical modulator module having a micro-heater and a temperature sensor that can control temperature in order to prevent an error of the operation of an optical modulator caused by the temperature.

The present invention also provides an optical modulator module that can make the operation of an optical modulator stable within a shorter during of time directly after a power is supplied to the optical modulator module.

The present invention also provides an optical modulator module that can simply control the temperature of an optical modulator without a specific additional process in the processes of manufacturing the optical modulator module.

The present invention provides an optical modulator module that can be used for miniaturized electronic products because of using a micro-heater to control the temperature of an optical modulator.

The present invention provides an optical modulator module that can output a high quality image by mounting and controlling a cooling unit to allow the temperature of an optical modulator to be uniformed any time or any space in the optical modulator module.

The present invention provides a temperature sensor tuning method and a temperature sensor manufactured by the same that can minimize an error caused in the process of manufacturing the temperature sensor.

The present invention provides a temperature sensor tuning method and a temperature sensor manufactured by the same that is applicable to miniaturized electronic products.

An aspect of the present invention features an optical modulator module including an optical modulator, modulating a beam of light emitted from a light source and emitting the modulated beam of light; and a micro-heater, manufactured in the optical modulator. At this time, a line of a micro-heater can be formed close to an edge of the micro-heater along an inside of the edge, and the micro-heater can be manufactured on a surface on which a mirror of the optical modulator.

Also, the micro-heater can be manufactured on a surface opposite to a surface on which a mirror of the optical modulator. At this time, a line of a micro-heater can be formed to have a zigzag shape on the micro-heater.

The micro-heater can be made of any one of a copper thin film and a platinum thin film. The micro-heater can control a temperature of the optical modulator according to a driving by on/off of a power of the micro-heater or according to a current flowing through the micro-heater.

The optical modulator module can further include a temperature sensor measuring a temperature of the optical modulator. At this time, the temperature sensor can be any one of a resistance temperature detector (RTD) temperature sensor, which is made of any one of copper and platinum, and a thermistor.

Another aspect of the present invention features an optical modulator module.

According to an embodiment of the present invention, the optical modulator module can include an optical modulator, having one surface formed with a mirror surface receiving a beam of light and modulating the receive beam of light before outputting the modulated beam of light; and a cooling unit, being in touch with another surface of the optical modulator or arranged at a point, vertically spaced with another surface of the optical modulator at a predetermined distance

The cooling unit can be a thermoelectric cooler using the Peltier effect.

The optical modulator module can further include a spacing part forming a spacing space in a vertical direction from another surface of the optical modulator. At this time, the cooling unit can be arranged in the spacing space

A temperature sensor can be arranged at a different point from the point at which the cooling unit is arranged in the spacing space.

The temperature sensor can be any one of a resistance temperature detector (RTD) temperature sensor and a thermistor.

The cooling unit can be a thermoelectric cooler using the Peltier effect, and the optical modulator module can further include a control circuit controlling a current flowing through the cooling unit according to a temperature measured by the temperature sensor.

The control circuit can controls a direction of a current flowing through the cooling unit in case that the temperature measured by the temperature sensor is equal to or higher than a predetermined operation threshold to be opposite to a direction of the current flowing through the cooling unit in case that the temperature measured by the temperature sensor is lower than the predetermined operation threshold.

The optical modulator can be formed with a plurality of micromirrors arranged in a line, and the cooling unit can be formed to include a plurality of sub cooling units arranged on another surface corresponding to each of the plurality of micromirrors The plurality of sub cooling unit can have a contact size changed according to each position of the micromirrors.

The sub cooling unit can a thermoelectric cooler using the Peltier effect, and the sub cooling unit can be formed to include a semiconductor that is doped with a different doping level according to each position of the micromirrors.

According to an embodiment of the present invention, the optical modulator module can include an optical modulator, having one surface formed with a mirror surface receiving a beam of light and modulating the receive beam of light before outputting the modulated beam of light; a spacing part, made of a metal and forming a spacing space in a vertical direction from another surface of the present invention; a heat conducting unit, arranged at the spaced space and absorbing a heat from the optical modulator; and a cooling unit, arranged at a surface opposite to a surface in which the heat conducting unit is arranged.

The cooling unit can be a thermoelectric cooler using the Peltier effect.

According to another embodiment of the present invention, the optical modulator module can include an optical modulator, having one surface formed with a mirror surface receiving a beam of light and modulating the receive beam of light before outputting the modulated beam of light; a spacing part, made of a metal and forming a spacing space in a vertical direction from another surface of the present invention; a heat conducting unit, arranged at the spaced space and absorbing a heat from the optical modulator; an optical substrate, being in contact with the one surface of the optical modulator; and a cooling unit, arranged at a surface opposite to a surface in which the heat conducting unit is arranged.

The cooling unit can include a heat sink formed at a side opposite to the optical substrate.

The cooling unit can be formed to include a first cooling unit and a second cooling unit, and the first cooling unit and the second cooling unit can be spaced from each other to have a space therebetween capable of allowing a beam of light to be incident and a modulation beam of light, modulated by the optical modulator, to be outputted through the optical substrate.

Another aspect of the present invention features a cooling method.

According to an embodiment of the present invention, a cooling method can include allowing a temperature sensor included in the optical modulator module to measure a temperature of an inside of an optical modulator; allowing a control circuit included in the optical modulator module to control a direction of a current flowing through the TEC in case that the temperature measured by the temperature sensor is equal to or higher than a predetermined operation threshold to be opposite to a direction of the current flowing through the TEC in case that the temperature measured by the temperature sensor is lower than the predetermined operation threshold; and allowing the TEC to absorb or discharge the heat of the optical modulator according to a control of the control circuit.

Another aspect of the present invention features a recorded medium recorded a program for executing a cooling method.

According to an embodiment of the present invention, a recorded medium recorded with a program of instructions executable by a thermoelectric cooler (TEC) included in an optical modulator module to execute a method for cooling an optical modulator included in the optical modulator module, including allowing a temperature sensor included in the optical modulator module to measure a temperature of an inside of an optical modulator; allowing a control circuit included in the optical modulator module to control a direction of a current flowing through the TEC in case that the temperature measured by the temperature sensor is equal to or higher than a predetermined operation threshold to be opposite to a direction of the current flowing through the TEC in case that the temperature measured by the temperature sensor is lower than the predetermined operation threshold; and allowing the TEC to absorb or discharge the heat of the optical modulator according to a control of the control circuit.

Another aspect of the present invention features a temperature sensor including a substrate; a plurality of electrodes, arranged on the substrate; a plurality of fixed resistances, having an end part connected to each of the electrodes and connected to each other; and a plurality of variable resistances, connected in parallel and successively severed according to a current flowing between the electrodes.

At this time, the fixed resistance can include a contact fixed resistance, having one end part connected to the electrode; a noncontact fixed resistance, disconnected to the electrode; and a bridge fixed resistance, connecting the contact fixed resistance and the noncontact fixed resistance. A thermistor, a resistance temperature detector (RTD or both can be used for the fixed resistance and the variable resistance.

Also, at least one of the plurality of variable resistances can have a different width from those of the other variable resistances. The plurality of variable resistances can be connected between the fixed resistances to have a small basic resistance than a desired resistance, and the basic resistance can refer to a composite resistance of the variable resistances and the fixed resistances before the variable resistances are severed. The fixed resistance and the variable resistance can be made of platinum Pt, gold Au, copper Cu and/or tungsten W. The temperature sensor is applicable to any one of a reflective type, a transmissive type and a diffractive type of the optical modulator.

Another aspect of the present invention features a temperature sensor tuning method, including placing a plurality of electrodes on a substrate; connecting a plurality of fixed resistances in one surface of the electrode or an upper part of the substrate; placing a plurality of variable resistances connecting between the fixed resistances; and severing connection between the plurality of variable resistances and the fixed resistances according to a desired resistance.

At this time, the step of severing connection between the plurality of variable resistances and the fixed resistance can include measuring a resistance value between the electrodes arranged on the substrate; comparing the measured resistance value with a desired resistance; severing any one of the plurality of variable resistances connecting the fixed resistances if a difference between the measured resistance value and the desired resistance is beyond a range capable of considering that the measured resistance value is identical to the desired resistance.

### BRIEF DESCRIPTION OF THE DRAWINGS

These and other features, aspects and advantages of the present invention will become better understood with regard to the following description, appended claims and accompanying drawings where:

FIG. 1 shows a brief structure of the whole system of a display apparatus using an optical modulator module in accordance with an embodiment of the present invention;

FIG. 2A is a perspective view showing a type of a micromirror of an optical modulator using a piezoelectric element among indirect optical modulators applicable to the present invention;

FIG. 2B is a plan view showing an optical modulator including a plurality of micromirrors among spatial optical modulators applicable to an embodiment of the present invention;

FIG. 3 is a sectional view showing an optical modulator module including an optical modulator in accordance with an embodiment of the present invention;

FIG. 4A and FIG. 4B show examples of a micro-heater in accordance with an embodiment of the present invention;

FIG. 5 shows the structure of an optical modulator module including a temperature sensor in accordance with an embodiment of the present invention;

FIG. 6 shows the change of temperature of an optical modulator according to the change of external temperature;

FIG. 7 shows the change of lengthwise direction of an optical modulator in accordance with an embodiment;

FIG. 8 is a plan view, a side view and a front view showing the conventional optical modulator module including an optical modulator;

FIG. 9 shows an optical modulator module including a cooling unit in accordance with an embodiment of the present invention;

FIG. 10 shows a cooling unit included in an optical modulator module in accordance with another embodiment of the present invention;

FIG. 11 is a front view showing the structure of an optical modulator module including a heat conductive unit and a cooling unit in accordance with another embodiment of the present invention;

FIG. 12 is a front view showing the structure of an optical modulator module including a heat conductive unit and a cooling unit in accordance with another embodiment of the present invention;

FIG. 13 shows the structure of a temperature sensor that can perform tuning in accordance with an embodiment of the present invention;

FIG. 14, FIG. 15 and FIG. 16 show each structure of temperature sensors that can perform tuning in accordance with various embodiments of the present invention;

FIG. 17 shows the structure of a temperature sensor that can perform tuning in accordance with another embodiment of the present invention;

FIG. 18 shows the structure of a temperature sensor that can perform tuning in accordance with another embodiment of the present invention;

FIG. 19 shows the change of resistance when the temperature of FIG. 18 performs tuning; and

FIG. 20 is a flow chart showing a temperature sensor tuning method in accordance with an embodiment of the present invention.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments of the present invention will be described in detail with reference to the accompanying drawings. Throughout the drawings, similar elements are given similar reference numerals. The pertinent detailed description will be omitted.

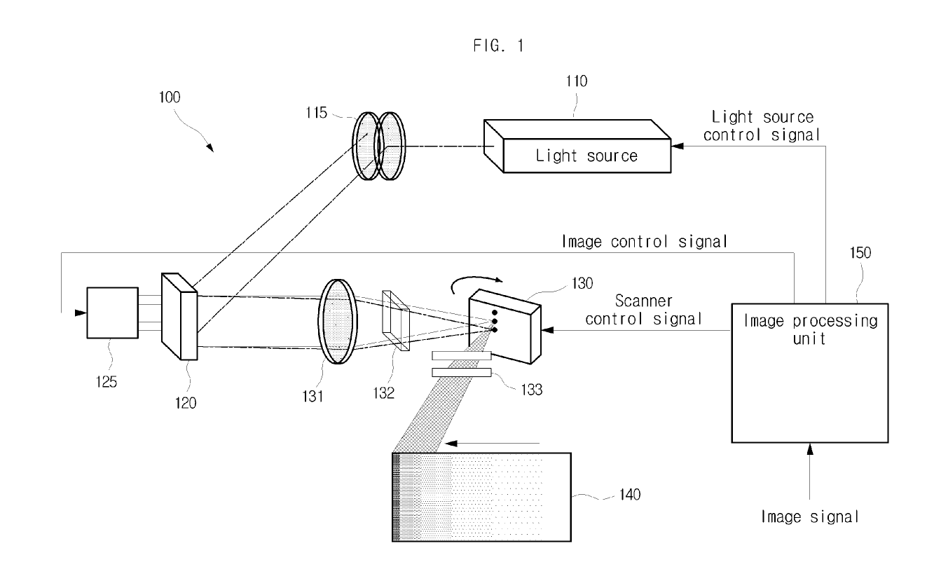

Hereinafter, the brief structure of a display apparatus using an optical modulator module in accordance with an embodiment of the present invention will be described with reference to FIG. 1.

FIG. 1 shows a brief structure of the whole system of a display apparatus using an optical modulator module in accordance with an embodiment of the present invention.

The display apparatus 100 can include a light source 110, an optical modulator 120, a driving circuit 125, a scanner 130 and an image processing unit 150. In accordance with an embodiment of the present invention, the light source 110, the modulator 120, the driving circuit 125 and the scanner 130 can be included in a projection unit of the display apparatus 100.

The light source 110 can emit a beam of light to allow an image to be projected on a screen 140. The light source 110 can emit a white beam of light, or any one or all of a red beam, a green beam and a blue beam of light, which are the three primary colors of light. Herein, the light source 110 can employ a light amplification by stimulated emission of radiation (LASER), a light-emitting diode (LED) or a laser diode. In the case of emitting the white light, a color dividing unit (not shown) can be provided to divide the white beam of light into the red beam, the green beam and the blue bema of light. Also, all beams including the red beam, the green beam and the blue bema of light can be successively emitted in any order.

A lighting optical system 115 can be placed between the light source 110 and the optical modulator 120. The lighting optical system 115 can reflect the light emitted from the light source 110 at a predetermined angle in order to allow the light to be concentrated on the optical modulator 120. If colors are divided by a color dividing unit (not shown), the operation of allowing the light to be concentrated can be additionally performed.

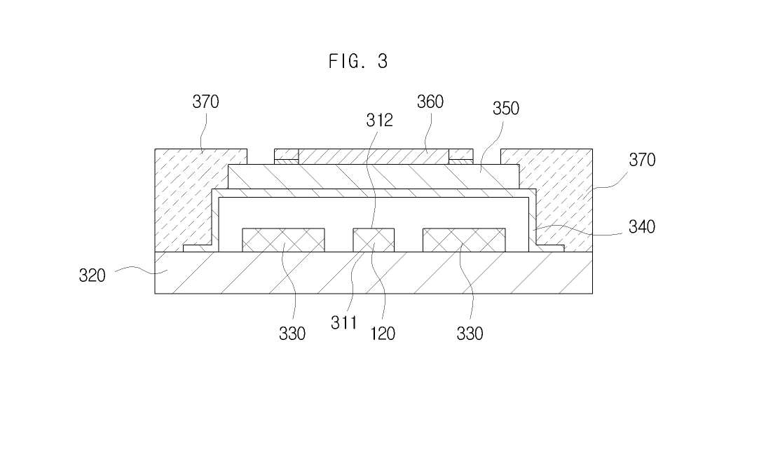

According to a driving signal supplied from the driving circuit 125, the optical modulator 120 can modulate light corresponding to incident light emitted from the light source 110 before outputting the modulated light. The optical modulator 120 and the driving circuit 125 can correspond to an optical modulator module to be later described with reference to FIG. 3.

The optical modulator 120, which is configured to include a plurality of micro-mirrors arranged in a line, can deal with a linear image corresponding to a vertical scanning line or a horizontal scanning in one image frame. In other words, when it comes to the linear image, the optical modulator 120 can modulate light corresponding to incident light having a changed luminance before outputting the modulated light by adjusting each displacement of the micromirrors corresponding to each pixel of the linear image according to a supplied driving signal.

The number of a plurality of micromirrors can be identical to that of pixels constituting a vertical or horizontal line or their multiples. The modulated light, which is the light applied with image information (i.e. a luminance value of each pixel constituting a vertical or horizontal scanning line) of a vertical or horizontal scanning line to be projected later on the screen 140, can be 0^{th}, +n^{th} or −n^{th} order diffracted light, n being a natural number.

The driving circuit 125 can supply to the optical modulator 120 a driving signal changing the luminance of modulated light outputted according to an image control signal supplied from the image processing unit 150. The driving signal that the driving circuit 125 supplies to the optical modulator 120 can be a driving voltage or a driving circuit.

A focusing optical system 131 can allow the modulated light outputted from the optical modulator 120 to be transferred to the scanner 130. The focusing optical system 131 can include at least one lens. Also, the focusing optical system 131 adjusts the magnification, as necessary, to transfer the modulated light enlarged or contracted according to the size ratio of the optical modulator 120 and the scanner 130.

The scanner 130 can reflect modulated light incident from the optical modulator 120 at a predetermined angle and projects the light on the screen 140. At this time, the predetermined angle can be determined by a scanner control signal inputted from the image processing unit 150. The scanner control signal can be synchronized with an image control signal and allow the scanner 130 to be rotated at an angle. At this time, the modulated light can be projected on a vertical (or horizontal) line position of the screen 140 corresponding to the scanner control signal at the angle.

In particular, the scanner control signal can include information related to a driving speed and a driving angle. The scanner 130 can be rotated according to the driving angel and speed in order to be placed on a position at a point of time. The scanner 130 can be a polygon mirror, a rotating bar, or a Galvano mirror, for example.

The modulated light transferred from the optical modulator 120, as described above, can be 0^{th}, +n^{th} or −n^{th} order diffracted light. Each diffracted light can be projected on the screen 140 by the scanner 130. In this case, since the path of each diffracted light is different, a slit 133 can be included. The slit 133 can allow desired order diffracted light to be selected and to be projected on the screen 140.

A projection optical system 132 can allow the modulated light transferred from the optical modulator 120 to be projected on the scanner 130. Herein, the projection optical system 132 can include a projection lens (not shown).

The image processing unit 150 can receive an image signal corresponding to one image frame and transmit the received image signal to the driving signal 125. Also, the image processing unit 150 can supply a scanner control signal and a light source control signal to the scanner 130 and the light source 110, respectively. In other words, the image control signal, the scanner control signal and the light source control signal can be synchronized with each other so as to control the rotated angle of the scanner 130 or the light source 110. As such, the scanner control signal and the light source control signal, which are linked with each other, make it possible to display one frame image on the screen 140.

Below is described the optical modulator 120 applicable to the present invention.

The optical modulator is mainly divided into a direct type, which directly controls the on/off state of light, and an indirect type, which uses reflection and diffraction. The indirect type can be further divided into an electrostatic type and a piezoelectric type. Here, the optical modulator is applicable to the present invention regardless of the operation type.

An electrostatic type grating optical modulator includes a plurality of regularly spaced reflective ribbons having reflective surfaces and suspended above an upper part of the substrate, the spaced distances of the reflective ribbons being adjustable.

First, an insulation layer is deposited onto a silicon substrate, followed by depositions of a silicon dioxide film and a silicon nitride film. Here, the silicon nitride film is patterned with the ribbons, and some portions of the silicon dioxide film are etched such that the ribbons can be maintained by a nitride frame on an oxide spacer layer.

The grating amplitude, of the modulator limited to the vertical distance d between the reflective surface of the ribbon and the reflective surface of the substrate, is controlled by supplying a voltage between upper and lower parts of the ribbon (i.e. the reflective surface of the ribbon, which acts as a first electrode).

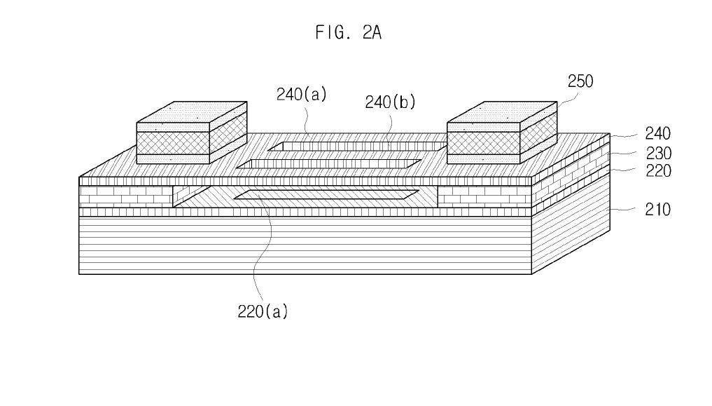

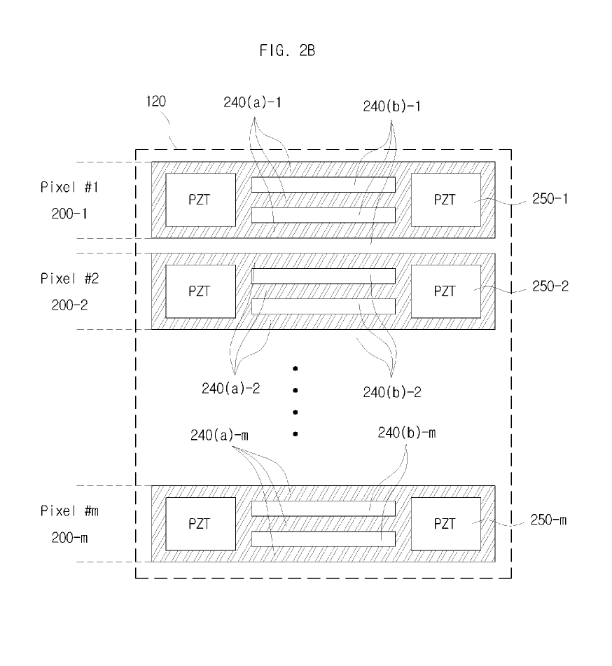

Hereinafter, the optical modulator will be described in detail with reference to FIG. 2A and FIG. 2B.

FIG. 2A is a perspective view showing a type of a micromirror of an optical modulator using a piezoelectric element among in direct optical modulators applicable to the present invention.

A transmissive optical modulator or a reflective optical modulator as well as a diffractive optical modulator can be used for the optical modulator module that controls the temperature of an optical modulator through a cooling unit in accordance with the present invention. The optical modulator module of the present invention is not limited to types of the optical modulator. The below description focuses on the diffractive optical modulator.

Referring to FIG. 2A, the micromirror including a substrate 210, an insulation layer 220, a sacrificial layer 230, a ribbon structure 240 and a piezoelectric element 250 is illustrated. In other words, the optical modulator can be structured to include one surface having a mirror surface formed with micromirrors and another surface which is a substrate.

The substrate 210 is a commonly used semiconductor substrate, and the insulation layer 220 is deposited as an etch stop layer. The insulation layer 220 is formed from a material with a high selectivity to the etchant (an etching gas or an etching solution) that etches the material used as the sacrificial layer 230. Here, a lower reflective layer 220(a) can be formed on the insulation layer 220 to reflect incident beams of light.

The sacrificial layer 230 supports the ribbon structure 240 at opposite sides such that the ribbon structure 240 can be spaced by a constant gap from the insulation layer 220, and forms a space in the center part.

The ribbon structure 240 creates diffraction and interference in the incident light to perform optical modulation of signals. The ribbon structure 240 can be formed in a plurality of ribbon shapes, or can include a plurality of open holes 240(b) in the center portion of the ribbons. Also, the piezoelectric element 250 controls the ribbon structure 240 to move upwardly and downwardly according to upward and downward, or leftward and rightward contraction or expansion levels generated by the voltage difference between the upper and lower electrodes. In other words, the piezoelectric effect can be inversely used.

In this case, the temperature can have an effect on the contraction or expansion of the piezoelectric element and the position of the ribbon structure 240, which causes diffraction and interference. This makes outputted modulation light irregular.

Before describing the change of temperature having an effect on the optical modulator, the process of allowing the optical modulator to modulate incident light will be described later.

The lower reflective layer 220(a) of the optical modulator can be formed corresponding to a hole 240(b) on formed the ribbon structure 240. For example, in case that the wavelength of a beam of light is λ, a first voltage is supplied to the piezoelectric elements 250. At this time, the first voltage allows the gap between an upper reflective layer 240(a), formed on the ribbon structure 240, and the lower reflective layer 220(a), formed on the insulation layer 220, to be equal to (2 l)λ/4, l being a natural number. In the case of a 0^{th}-order diffracted (reflected) beam of light, the overall path length difference between the light reflected by the upper reflective layer 240(a) and the light reflected by the lower reflective layer 220(a) is equal to lλ, so that constructive interference occurs and the diffracted light renders its maximum luminance. In the case of +1^{st} or −1^{st} order diffracted light, however, the luminance of the light is at its minimum value due to destructive interference.

Also, a second voltage is supplied to the piezoelectric elements 250. At this time, the second voltage allows the gap between an upper reflective layer 240(a), formed on the ribbon structure 240, and the lower reflective layer 220(a), formed on the insulation layer 220, to be equal to (2 l+1)λ/4, l being a natural number. In the case of a 0^{th}-order diffracted (reflected) beam of light, the overall path length difference between the light reflected by the upper reflective layer 240(a) formed on the ribbon structure 240 and the light reflected by the insulation layer 220(a) is equal to (2 l+1)λ/2, so that destructive interference occurs, and the diffracted light renders its minimum luminance. In the case of +1^{st} or −1^{st} order diffracted light, however, the luminance of the light is at its maximum value due to constructive interference.

As a result of such interference, the micromirror can load a signal for one pixel on the beam of light by adjusting the quantity of the reflected or diffracted light. Although the foregoing describes the cases in which the gap between the ribbon structure 240 and the insulation layer 220 is (2 l)λ/4 or (2 l+1)λ/4, it shall be obvious that a variety of embodiments can be applied to the present invention, in which adjusting the gap between the ribbon structure 240 and the insulation layer 220 is able to control the luminance of light interfered by diffraction and/or reflection of the incident light.

The position of the above-described micromirror can be adjusted by using a piezoelectric type. Also, the position of the micromirror may be changed according to the temperature of the optical modulator. In this case, since it is impossible to create desired constructive or destructive interference by accurately adjusting the gap between the ribbon structure 240 and the insulation layer 220, an error may occur according to the change of temperature of environments in the piezoelectric control method of the optical modulator. Keeping the display apparatus used may result in the increased temperature, to thereby unable to continue outputting the same quality image.

The below-described optical modulator module having a cooling unit to maintain a regular temperature can be applied to the display apparatus having the forgoing diffractive optical modulator. In other words, in portable electronic equipment such as mobile phones, personal digital assistants (PDA) and laptop computers, the present invention can be applied to their display devices having projection display units in order to reduce the power consumption.

As described above, in case that the optical modulator module having the optical modulator is applied to the foregoing portable electronic equipment, the heat generated from the other elements in the portable electronic equipment may be transferred to the optical modulator module, which results in the increased temperature of the optical modulator, to thereby unable to continue outputting the same quality image.

For example, since the mobile phone has the variable operation temperature between −20□ and 60□ the optical modulator of the optical modulator module may be severely affected by the temperature.

Accordingly, in accordance with an embodiment of the present invention, the cooling unit included in the optical modulator may be required to regularly maintain the temperature of the optical modulator according to the variable temperature range of Δ80□. Here, the variable temperature range of Δ80□ is merely an example of an embodiment of the present invention. The other display apparatuses can have a different temperature range.

If the optical modulator module is inserted into the mobile phone, the cooling unit can prevent the temperature from being increased when the optical modulator module is used and images are projected on an external screen to perform image call, DMB and VOD service.

The temperature difference in positions generated due to the structural characteristics of the optical modulator including a plurality of micromirrors will be described below.

FIG. 2B is a plan view showing an optical modulator including a plurality of micromirrors among indirect optical modulators applicable to the present invention;

Referring to FIG. 2B, the optical modulator 120 can be configured to include m micro-mirrors 200-1, 200-2, . . . , and 200-m, each of which corresponds to a first pixel (pixel #1), a second pixel (pixel #2), . . . , and an m^{th} pixel (pixel #m), respectively, m being a natural number. The optical modulator 120 deals with image information with respect to 1-dimensional images of vertical or horizontal scanning lines (which are assumed to consist of m pixels), while each micro-mirror 200-1, 200-2, . . . , and 200-m deals with one pixel among the m pixels constituting the vertical or horizontal scanning line.

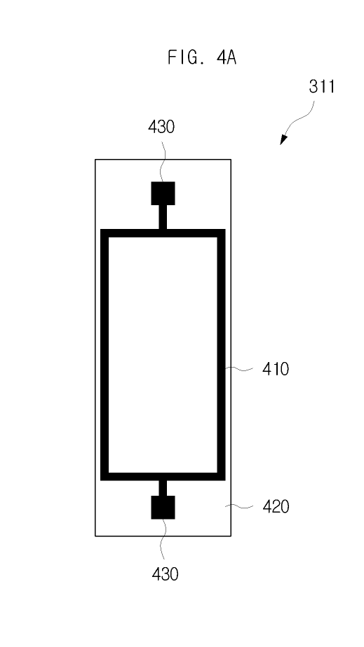

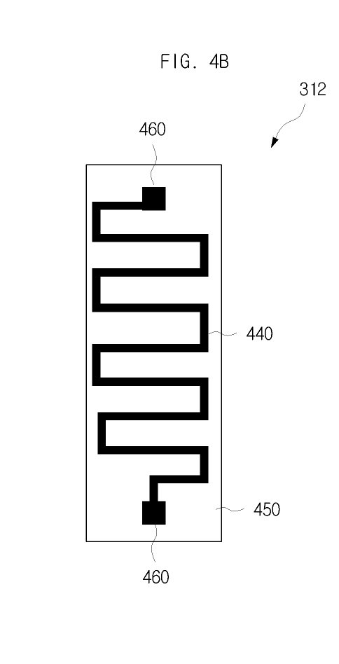

In this case, each micro-mirror 200-1, 200-2, . . . , and 200-m may have different temperatures. In particular, the temperature may be differentiated according to the internal position of the optical modulator module. This will be described later with reference to FIG. 4.

Accordingly, each piezoelectric element 250-1, 250-2, . . . and 250-m may have the operation characteristics that are changed according to the temperature, to thereby allow the position changes of each upper reflective layer 240(a)-l, 240(a)-l, . . . and 240(a)-m and holes 240(b)-l, 240(b)-l, . . . and 240(b)-m to become different in spite of the same voltage.

For example, in the case of a VGA resolution of 640*480, when the modulation is performed 640 times for 480 vertical pixels in one surface of an optical scanning device (not shown), to thereby generate one frame of display having a resolution of 640*480, the pixels of the center part and the edge part of a screen may have different contrast values.

The below description with reference to FIG. 3 shows how much the temperature of the optical modulator module is affected by the heat generated by the portable electronic equipment having the optical modulator module or the surrounding heat.

Hereinafter, the structure of an optical modulator module having the forgoing optical modulator will be described with reference to FIG. 3. FIG. 3 is a sectional view showing an optical modulator module including an optical modulator in accordance with an embodiment of the present invention.

An optical substrate 320, which is placed at the bottom, can be formed to include a light-transmissive material such as glass and receive a beam of light emitted from the light source 110. An optical modulator 120 can be placed in a surface of the optical substrate 320. As described above, the optical modulator 120 can adjust the luminance by reflecting and/or diffracting the beam of light incident from the light source 110. A driving IC 330 can be placed at both sides of the optical modulator 120.

The driving IC 330 can control the operation of the optical modulator 120. In addition to the driving IC 330 and the optical modulator 120, a spacing part 340 and a passivation layer 370 can be placed at the surface of the optical substrate 320. At this time, the spacing part 340 can project the optical modulator 120 against an external environment by sealing the optical modulator 120 and enhance the flatness and the bonding force in the PCB bonding. A connector 360 placed at an upper part of a PCB can transfer an image signal, received from the image processing unit 150 described with reference to FIG. 1, or a power to the driving IC 330.

As described above, the optical modulator 120 can modulate an incident beam of light by adjusting the positions of the micromirrors by the electrostatic type and the piezoelectric type before emitting the modulated beam of light. At this time, the positions of upper mirrors can be changed according to the temperature. Here, the upper mirrors refer to the micromirrors placed above the sacrificial layer 230 for the convenience of description. Accordingly, in order to correct some errors caused by the change of positions, it may be necessary to develop the method for increasing a variable position range considering the change of positions of the upper mirrors according to the change of temperature. However, the currently developed technology may make it difficult to develop the method.

However, controlling the temperature of the optical modulator 120 like the present invention makes it possible to output a modulation beam of light having desired brightness by the optical modulator 120 without the increase of the variable position ranges.

In an embodiment of the present invention, a micro-heater can be placed at a first surface or a second surface 312 of the optical modulator 120. Here, the first surface 311 of the optical modulator 120 can be the same as the surface on which the micromirrors of the optical modulator 120 are placed. The second surface 312 of the optical modulator 120 to which no light is incident, can be opposite to the surface on which the micromirrors of the optical modulator 120 are placed.

By allowing the micro-heater to be directly placed close to the optical modulator 120, the heat generated by the micro-heater can be directly transferred to the optical modulator 120, to thereby have good efficiency.

Hereinafter, the method for controlling the temperature of the optical modulator 120 by a micro-heater will be described in detail.

In accordance with an embodiment of the present invention, the micro-heater can be formed by using a thin film made of Pt or Au, which is a material used for a pad. Accordingly, the micro-heater can be simply manufactured without an additional process. The pad refers to an electrode for transferring signals to each micromirror of the optical modulator 120. As a result, the micro-heater can be manufactured by being added to the optical modulator module without adding a specific process to the process of manufacturing the optical modulator module.

At this time, the thickness, width and length of the micro-heater can be designed according to the following formula 1.

$$\begin{matrix}P = {I}^{2} R = \frac{{V}^{2}}{R} \\ R = ρ \frac{l}{s} = \frac{ρ l}{wh}\end{matrix} \qquad [ Formula 2 ]$$

In the formula 1, P refers to an electric power, and I refers to a current. V refers to a voltage. η refers to the specific resistance which is changed according to the material of resistance. l, s, h and w refer to the length, cross section, height and width of the resistance. In other words, the electric power can be determined according to the voltage and the resistance. At this time, the resistance value can be determined according to the length, cross section and height of the resistance as shown in the formula 2.

Since the micro-heater is a resistance itself, determining the material of the micro-heater causes the specific resistance to be selected. Accordingly, the length, cross section and height of the resistance can be determined according to the voltage and the power of the micro-heater.

Hereinafter, the micro-heater in accordance with an embodiment of the present invention will be described in detail with reference to FIG. 4A and FIG. 4B. FIG. 4A and FIG. 4B show examples of a micro-heater in accordance with an embodiment of the present invention.

FIG. 4A is an example showing a micro-heater placed at the first surface 311 of the optical modulator 120. As described above, the micro-heater, which is formed to include a metal thin film, can generate heat by supplying a current to the thin film. In accordance with an embodiment of the present invention, the micro-heater can be formed to include a Pt thin film 420. An electrode 430 can be formed in the thin film, and a line 410 connecting the opposite electrodes 430 can be formed. In the first surface 311 of the optical modulator 120, as shown in FIG. 4A, the line 410 can be formed close to the edge of the thin film 420 of the micro-heater along the inside of the edge.

This may be because the optical modulator 120 is placed at an upper part of the micro-heater formed in the surface 311 of the optical modulator 120. The current flowing through the line 410 can cause the micro-heater to be heated, which allows the micro-heater as a heat source.

FIG. 4B is an example showing a micro-heater placed in the second surface 312 of the optical modulator 120. Since there is no space restriction on the micro-heater placed in the second surface 312 unlike the micro-heater placed in the first surface 311, the shape of winding the line 440 may be different in order to enhance the uniformity of temperature. Opposite electrodes 460 and the line 440 connecting the opposite electrodes 460 can be placed in a thin film 450 of the micro-heater. At this time, the line 440 having a zigzag shape can be arranged, as shown in FIG. 4B.

However, the line 440 can be formed close to the edge of the thin film 450 of the micro-heater along the inside of the edge like the line 410 placed in the first surface 311 of the optical modulator 120.

Since both the uniformity of temperature and the length of resistance, which are easily variable according to the shape of winding the line of the micro-heater, may make the resistance value itself changed to cause the amount of the generated heat to be changed, the shape of the winded line can act as one of important factors in the manufacture of the micro-heater.

Below is described the change of temperature of the optical modulator according to the change of environmental temperature in the temperature control of the optical modulator with respect to the operation of the micro-heater. Here, the environmental temperature refers to the temperature inside the optical modulator module when the optical modulator module is actually operated, and the temperature of the optical modulator itself refers to the temperature inside the optical modulator module when the optical modulator module is actually operated.

When an operating signal is supplied to the optical modulator module in a normal temperature, the temperature of the optical modulator increased by the driving of the optical modulator can be changed according to the increased or decreased level of the environmental temperature. In other words, the increased environmental temperature can bring about raising the temperature of the optical modulator, and the decreased environmental temperature can cause the temperature of the optical modulator to be dropped. At this time, the increased or decreased level of the environmental temperature can be similar to that of the temperature of the optical modulator.

If the environmental temperature is varied after a power is actually supplied, the temperature of the optical modulator can be mostly changed in proportion to the changed environmental temperature by showing the difference of about 20 degree within about 5 minutes. It may take about 30 minutes to be completely changed in proportion to the changed environmental temperature.

As a result, it may take about 5 to 30 minutes for the temperature of the optical modulator to be varied according to the increased level of the environmental temperature caused by the driving circuit and the light source after a power is supplied. In other words, it may take some minutes to allow the optical modulator to be stably operated. This shows that an unstable image formed using the light modulated through the optical modulator may be displayed for some minutes directly after the power is supplied.

In accordance with an embodiment of the present invention, however, the heat can be supplied to the optical modulator by forming a micro-heater in one surface or another surface of the optical modulator, to thereby allow the temperature of the optical modulator to be easily varied in proportion to the change of the environmental temperature directly after the power is supplied. Accordingly, the optical modulator having the micro-heater can become stable within about 2 minutes immediately after the power is supplied. As a result, it can take a shorter period of time to allow an image, displayed directly after the power is supplied, to become stable.

As described above, the micro-heater can have an effect on the stability of the optical modulator module directly after the power is supplied and control the temperature of the optical modulator in the operation. The method for allow the micro-heater to control the temperature of the optical modulator can be largely divided into two methods. A first method is to control the on/off of the power, and a second method is to control the amount of a current flowing through the micro-heater.

The first method can allow the power supplied to the micro-heater to be turned on in order to raise the temperature of the optical modulator. Also, the first method can maintain the temperature of the optical modulator to a desired temperature for the normal operation of the optical modulator by allowing the power supplied to the micro-heater to be turned off if the temperature is higher than the desired temperature and by allowing the power supplied to the micro-heater to be turned on if the temperature is lower than the desired temperature.

The second method can adjust the amount of the current flowing through a line formed in a thin film of the micro-heater in order to control the level of heat generated in the micro-heater. In other words, the amount of power in proportion to the amount of the current can be controlled by adjusting the amount of the current. The change of the amount of power can cause the level of heat generated in the micro-heater to be varied. Accordingly, it is possible to control the temperature of the optical modulator.

Below is described a temperature sensor necessary to control the temperature of the optical modulator module including a micro-heater.

In an embodiment of the present invention, an RTD temperature sensor or a thermistor can be used for the temperature sensor. Here, RTD refer to resistance temperature detector. The RTD temperature sensor can use the characteristic that electric resistance is increased according to the change of temperature, and the thermistor, which is made of semiconductor, can use the characteristic of a resistance temperature coefficient that if the temperature is increased, the resistance is decreased (NTC or CTR) or increased (PTC).

Since the RTD temperature sensor or the thermistor having large resistance temperature coefficients for temperature make it easy to measure micro-temperature and perform a precise measurement, it is possible to miniaturize the RTD temperature sensor or the thermistor. In particular, the RTD temperature sensor using Pt can be considered as one of most popular materials thanks to good accuracy and reproducibility by sensibly reacting to the resistance varied according to the change of temperature.

In accordance with an embodiment of the present invention, the temperature sensor can be manufactured by using an RTD made of Pt or Au. At this time, in the RTD used for the temperature sensor, the relationship between the resistance and the temperature can be represented by using the following formula 3.

R=R₀[1+β(T−T₀] [Formula 3]

In the formula 3, R₀ refers to an initial resistance value, and α refers to a resistance temperature coefficient. T refers to a temperature, and To refers to an initial temperature. α can be varied according to a metal material. For example, Au has the α of 3.4×10⁻⁸/° C., and Pt has the α of 3.93×10⁻⁸/° C.

For example, in the case of Au, if the initial resistance is assumed to be 100Ω, the relationship R can be computed from the formula 3 as follows.

$$\begin{matrix}R = {R}_{0} [ 1 + α ( T - {T}_{0} ) ] \\ = 100 [ 1 + 3.4 \times {10}^{- 3} ( T - {T}_{0} ) ] \\ = 100 + 0.34 ( T - {T}_{0} )\end{matrix}$$

In other words, if the temperature is increased by 1 degree, the resistance can rise by 0.393%. Accordingly, the temperature can be measured through the change of resistance. Using the temperature makes it possible to control the temperature of the optical modulator.

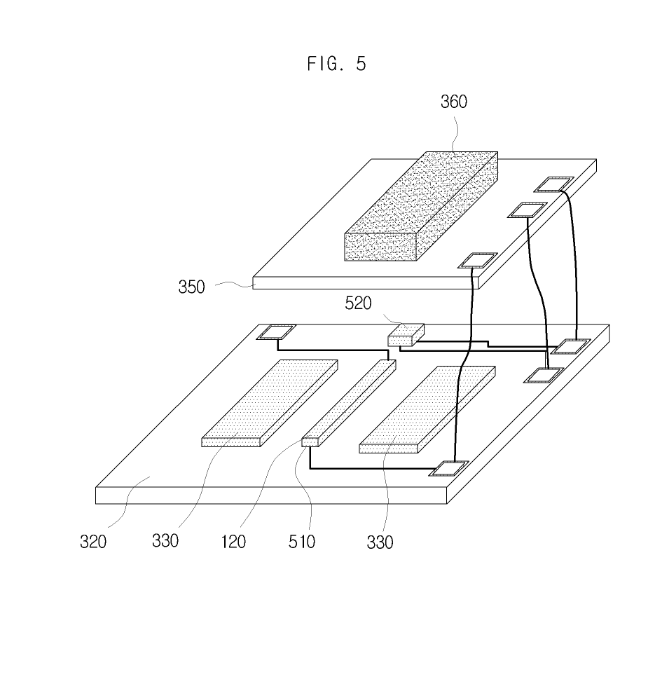

Hereinafter, the position of the temperature sensor in the optical modulator module will be described with reference to FIG. 5. FIG. 5 shows the structure of an optical modulator module including a temperature sensor in accordance with an embodiment of the present invention.

The driving circuit 330, the optical modulator 120 and the temperature sensor 520 can be mounted in an upper part of the optical substrate 320. In accordance with an embodiment of the present invention, the micro-heater can be manufactured in one surface 510 of the optical modulator 120. Alternatively, the micro-heater can be manufactured in another surface of the optical modulator 120, as described above.

The temperature sensor 520, which measures the temperature of the optical modulator 120, can control the operation of a micro-heater (not shown) by comparing the desired temperature, initially stored in the optical modulator module, guaranteeing the normal operation of the optical modulator with the temperature of the optical modulator, measured by the temperature sensor 520. In particular, as described above, the desired temperature can be maintained by comparing the temperature measured by the temperature sensor 520, with the desired temperature and allowing a power supplied to the micro-heater to be turned on or off or controlling the amount of a current flowing through the micro-heater. At this time, the temperature sensor 520 can be mounted in an upper part of the optical substrate 320 or inside the optical modulator 120, as shown in FIG. 5.

As such, in the case of controlling the temperature of the optical modulator by using the micro-heater, the variable temperature range can have the allowance of about 20 through 50 degree in accordance with an embodiment of the present invention. In particular, even though the environment temperature is changed to have the allowance of 0 to 30, it is possible to control the temperature of the optical modulator 120 and maintain the temperature to the desired temperature. Alternatively, it is possible to control the temperature of the variable temperature range having the wider allowance than 20 through 50, but the power consumption may be increased.

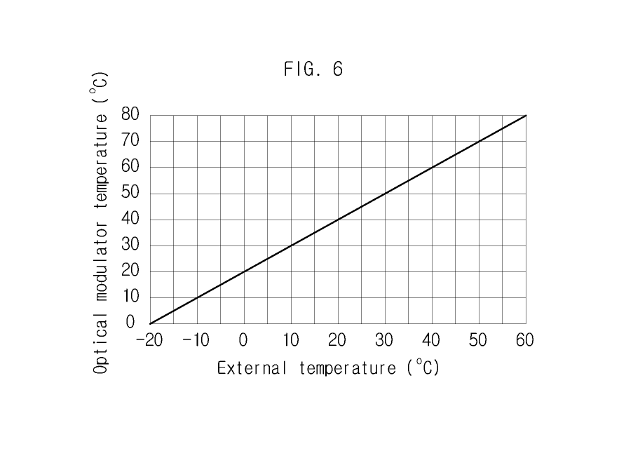

FIG. 6 shows the change of temperature of an optical modulator according to the change of external temperature.

Referring to FIG. 6, if the external temperature is variably changed from −20□ to 60□, the temperature of the optical modulator module can be correspondingly changed. Hereinafter, the temperature inside the optical modulator module is assumed to be the same as the temperature of the optical modulator 120.

In particular, the temperature of the optical modulator module can be +20□ higher than the temperature of surrounding environments according to the surrounding environments. Here, the elevated +20□ may be caused by the heat of the optical modulator module and the heat inherently generated by the driving IC inside the optical modulator module.

The point may be the temperature of the optical modulator module increased by the surrounding environments. Since the temperature of the optical modulator module increased by the surrounding environments shows that the temperature of the optical modulator 120 is variable according to the temperature of the surrounding environments, it may be required to maintain the variable temperature of the optical modulator 120 to a predetermined temperature in order to obtain a same brightness image.

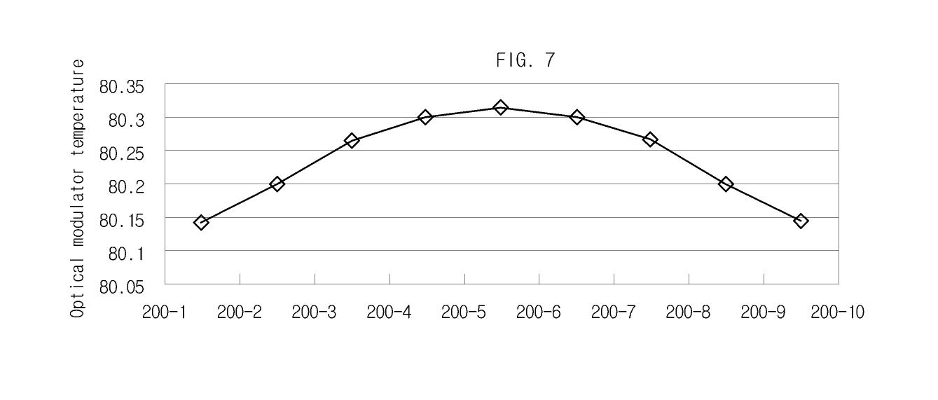

FIG. 7 shows the change of lengthwise direction of an optical modulator in accordance with an embodiment.

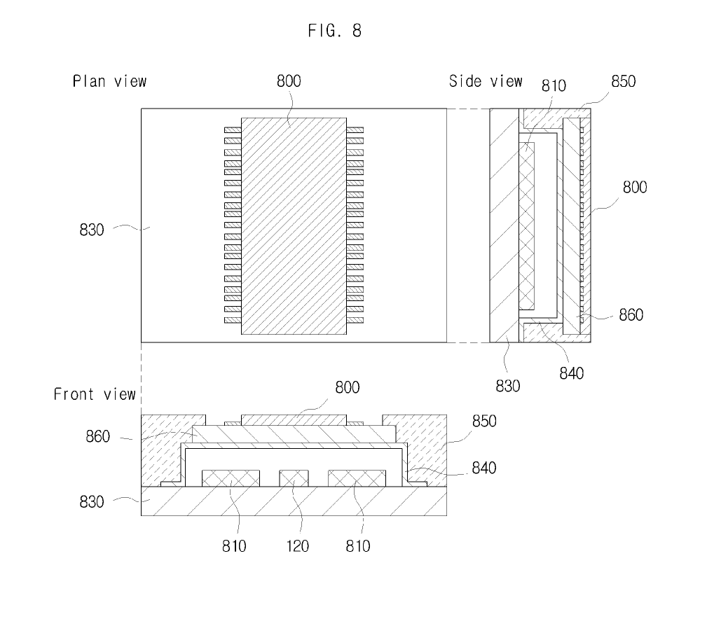

Referring to FIG. 7, it is recognized that a center part can show the higher temperature in the change of lengthwise direction of the optical modulator 120 in which micromirrors are arranged in a line. This may be because the heat, generated in the optical modulator 120 and transferred from the outside of the optical modulator 120, moves to the center part through the convection and the heat is exchanged with the outside to some extent through a passivation layer. The passivation layer can protect an upper part of the optical modulator module against dust, which will be described with reference to FIG. 8.

The optical modulator 120, as shown in FIG. 2B, can have the form in which a plurality of micromirrors are arranged in a line. Each micromirror can correspond to a pixel of an image to be projected on a screen. Accordingly, the different temperatures of each micromirror arranged in a line may cause outputted modulation light to have different characteristic in the center part and the edge part.

The change of lengthwise direction shown in FIG. 7 can indicate the change of temperature of the optical modulator 120 in accordance with an embodiment of the present invention. It shall be obvious that the change of lengthwise direction can show the different change of temperature caused by the size and structure of the micromirrors.

FIG. 7 shows the change of temperature in case that a total of 10 micromirrors are arranged. According to FIG. 7, the temperatures of a first micromirror 200-1 and a 10^{th} micromirror have about 80.15□, but the center part has the temperature of about 80.5□. The change of temperature of lengthwise direction has the variable range of Δ0.3□, which corresponds to a much smaller than the variable range of temperature of the optical modulator 120 changed according to the change of temperature of the surrounding environments.

The much smaller change of temperature, however, may have a minute effect on an outputted image. Accordingly, in another embodiment of the present invention, a cooling unit and a temperature sensor, which will be described later, can be included to uniformly maintain the temperature of lengthwise direction.

FIG. 8 is a plan view, a side view and a front view showing the conventional optical modulator module including an optical modulator.

Referring to the plan view of FIG. 8, a connector 800 can be connected. The connector 800 can transfer an image signal received from the image processing unit 150, described in FIG. 1, or a power to a driving IC 810. Accordingly, among elements of the optical modulator module, the connector 800 can be placed at a most upper part.

An optical substrate 830 can be placed in a lower part 830, and a light beam of light can be incident, reflected and diffracted from the direction inverse to a direction facing the connector 800 as shown in the front view of FIG. 8. The optical substrate 830 can have the structure allowing a beam of light to penetrate through the optical substrate 830. Herein, a grass can be used for the optical substrate 830, but is not limited to the present invention.

The front view of FIG. 8 shows the optical modulator 120. As described with reference to FIG. 2, the driving IC 810 can be placed at both sides of the optical modulator 120.

A spacing part 840 and a passivation layer 850 as well as the optical modulator 120 and the driving IC 810 can be settled at the optical substrate 850. The spacing part 840 can be used to seal the optical modulator 120 and the driving IC 810 and to support a circuit board 860. Here, the circuit board 860 can receive an image signal from the optical modulator module through the connector 800 and transfer the received image signal to the driving IC 810 driving the optical modulator 120 or transfer a power to inside of the optical modulator module.

The space formed by the spacing part 840 may be filled with air, not vacuum. Accordingly, the heat, generated in the driving IC 810 and transferred from the outside of the optical modulator module, can be transferred to the optical modulator 120 through the convection of air or the conduction of the optical substrate 830. The spacing part 840 can be configured to electrically connect the circuit board 860, the optical modulator 120 and the driving IC 810.

The optical modulator 120 can produce a mechanical movement by using a piezoelectric method. This may cause the position of the upper reflective layer to be changed. Accordingly, in order to correct an error caused by the change of position, the method of widening the variable position range of the upper mirrors considering the change of positions of the upper mirrors according to the change of temperature. However, the currently developed MEMS technology may make it difficult to apply to the optical modulator through miniaturization.
However, if it is possible to prevent the increasing of the temperature of the optical modulator caused by the heat generated in surroundings, a desired brightness modulation beam of light can be outputted without allowing the variable position range of the upper mirrors of the optical modulator 120 to be widened.

Further, since the increased temperature may allow the wavelength of a beam of light incident on the optical modulator 120 to be changed by Wien's displacement law, preventing the increase of temperature may help to obtain a high-quality image.

The temperature of the optical modulator can be lowered by discharging the heat generated in the inside, particularly, the heat of the optical modulator 120 to the outside. The heat may be generated in the driving IC 810 and transferred from the optical modulator module. Since the heat, as described above, is transferred to the optical modulator 120 through the convection and conduction, the heat of the optical modulator 120 can be directly discharged to the outside in order to most effectively obtain a high-quality image.

Accordingly, it can be considered as one of good examples that the optical modulator 120 is cooled by absorbing the heat from the optical modulator 120 and discharging the heat in a direction of the connector 800 or the optical substrate 830.

Hereinafter, an optical modulator module including a cooling unit in accordance with an embodiment of the present invention manufactured by mounting the cooling unit in the conventional optical modulator module will be described with reference to the related drawings.

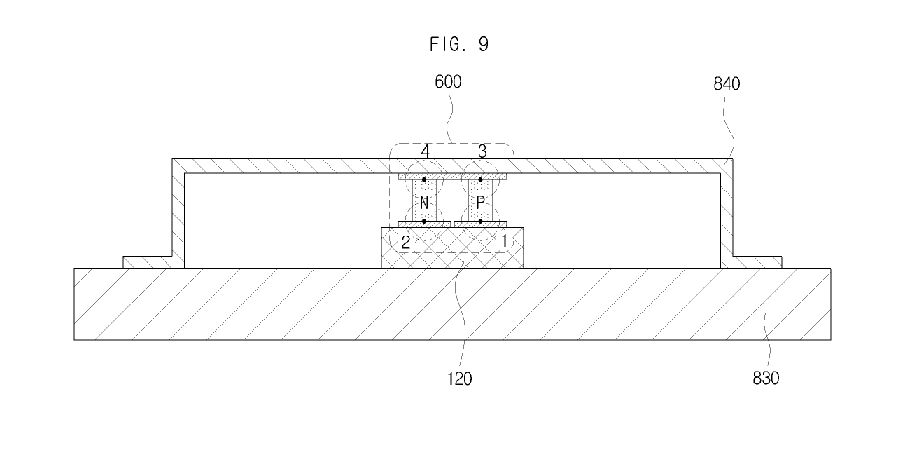

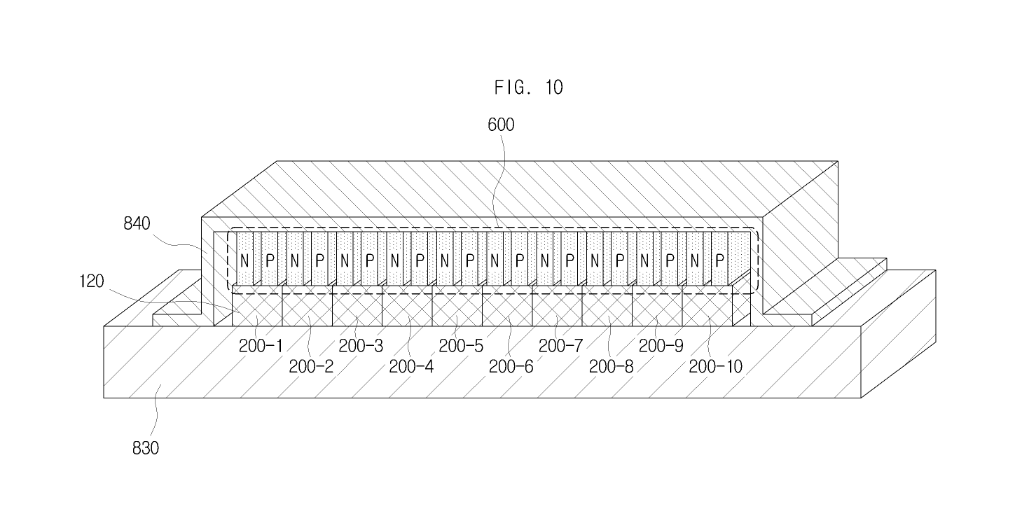

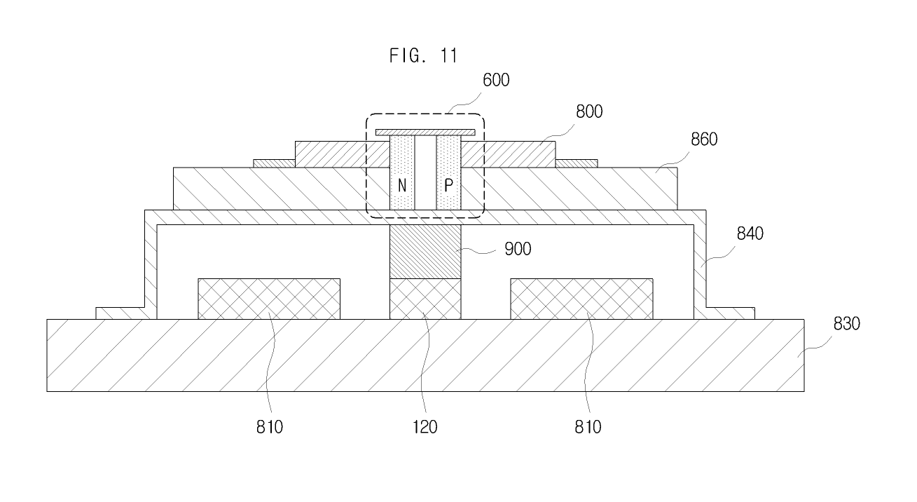

FIG. 9 shows an optical modulator module including a cooling unit in accordance with an embodiment of the present invention.

Referring to FIG. 9, a thermoelectric cooler (TEC), which acts as a cooling unit 600, can be inserted into a spaced space between the optical modulator 120 and the spacing part 600. Although various typed cooling devices can be used as the cooling unit 600, the below description focuses on the TEC and considers the TEC as the cooling unit 600. It can be considered as one of good examples that the TEC 600 has one surface which is in contact with one surface of the optical modulator 120 and another surface which is in contract with the spacing part 840.

If a current flows through the TEC 600 having a loop shape, formed by allowing a semiconductor and a metal to be alternately in contact with each other, the difference in Fermi energy can be generated, to thereby lead to the difference in voltage. This can cause the Peltier effect. In particular, an endothermic reaction, which is the cooling reaction, can be performed by allowing an electron to absorb some energy necessary for the electron to move from one side to the other side of the metal in the one side of the metal. In the other side of the metal, an exothermic reaction, which is the heating reaction, can be performed by allowing the electron to emit the absorbed energy. The TEC 600 is the thermoelectric element using the Peltier effect.

As a result, since the TEC 600 has the one side creating the cooling reaction and the other side creating the heating reaction, the one side creating the cooling reaction of the TEC 600 may be required to be in contact with the optical modulator 120. The surface on which the optical modulator 120 is in contact with the TEC 600 may be opposite to the surface of the optical modulator on which a beam of light is incident.

If a direct current is supplied to a circuit in which an N-type thermoelectric semiconductor N, a conductor and a P-type thermoelectric semiconductor P are connected in series, negative-charged contacts 1 and 2 can create the endothermic reaction by allowing an electron absorbing heat-energy from the optical modulator 120 to move to the inside of the thermoelectric semiconductor. Also, positive-charged contacts 3 and 4 can create the exothermic reaction by allowing the electron to emit the heat-energy.

Accordingly, it is possible to prevent the temperature of the optical modulator 120 from being increased and to keep the temperature regular. For example, in the case of applying to a mobile phone as described with reference to FIG. 4, since the operation temperature of the mobile phone is changed from −20□ to 60□ and the temperature of the optical modulator is also correspondingly changed from 0□ to 80□, the operation temperature may be required to bee regularly maintained.

Since it is required to measure the temperature of the optical modulator 120 in order to regularly maintain the operation temperature of the mobile phone, a temperature sensor (e.g. thermistor) can be placed in the optical modulator module in order to measure the temperature of the optical modulator 120. Here, the thermistor is the temperature sensor manufactured in order that the minute change of temperature can result in the big change of resistance. In particular, a negative temperature coefficient of resistor (NTC) can be used for the thermistor, which uses a negative resistance temperature coefficient showing that the increased temperature results in decreasing the resistance, unlike a metal.

Alternatively, the temperature sensor can be a resistance temperature detector (RTD). The RTD can use the principle that since the electric resistance of a metal is changed according to the change of temperature, it is possible to recognize the change of temperature through the change of electric resistance. Herein, tungsten W, copper Cu, nickel Ni and/or platinum Pt can be used.

In case that the temperature of the outside is lower and the temperature of the inside of the optical modulator measured by the temperature sensor is 0□, if the direction of the current flowing the TEC 600 is changed, the contacts 1 and 2 can create the exothermic reaction and the contacts 3 and 4 can create the endothermic reaction. This may be obviously resulted from the reverse flow of electrons and halls.

For example, in case that the temperature of the optical modulator is 0□, if the operation temperature of the optical modulator 120 is desired to be maintained to 40□, it may be requited to supply a current such that the contacts 1 and 2 can create the exothermic reaction. Of course, the temperature of the optical modulator 120 can be varied according to the properties of the optical modulator 120 and the external conditions.

If the temperature of the optical modulator 120 is equal to or higher than 40□ by allowing the surrounding temperature of the optical modulator module to be equal to or higher than 20□ due to the ongoing use of the display apparatus, the temperature sensor can sense the temperature of the optical modulator 120.

In this case, if the direction of the current flowing the TEC 600 is reversely changed again, the contacts 1 and 2 can create the endothermic reaction and the contacts 3 and 4 can create the exothermic reaction. Accordingly, the optical modulator 120 can be guaranteed to have the same operation temperature of 40□ by obtaining the cooling effect owing to the TEC 600.

In this case, the direction and magnitude of the current flowing through TEC 600 can be allowed to be controlled by inserting a separate control circuit (not shown) into the inside of the optical modulator module or by using the driving IC 810. Alternatively, the direction and magnitude of the current can be allowed to be controlled by the external image processing unit 150 or a separate micro processor connected through the circuit board 860. At this time, the arrangement of the control circuit is not limited to the present invention.

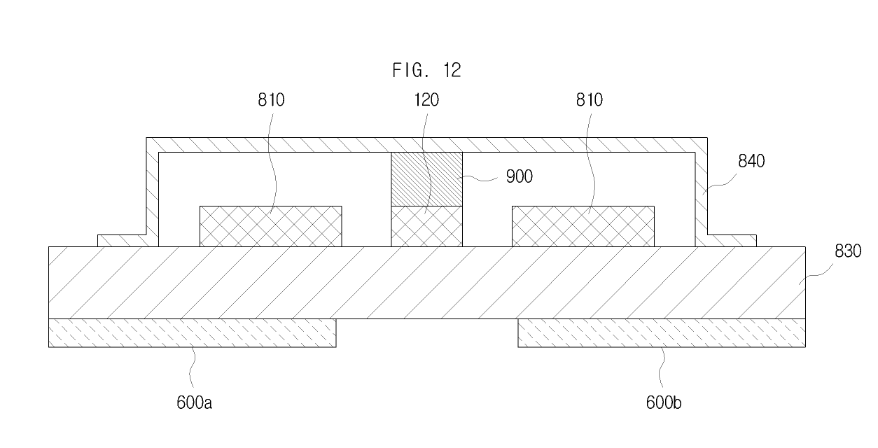

FIG. 10 shows a cooling unit included in an optical modulator module in accordance with another embodiment of the present invention.

Refer to FIG. 10, each TEC 600 can be arranged at upper parts of each micromirror 200-1, 200-2 and . . . 200-10. Although the description with reference to FIG. 10 is related to the optical modulator 120 including 10 micromirrors 200-1, 200-2 and . . . 200-10, the number of the micromirrors is not limited to this embodiment. Alternatively, the optical modulator 120 can include m micromirrors. Here, m is a natural number.

Since each TEC 600 processes the cooling of each micromirror 200-1, 200-2 and . . . 200-10, each TEC unit arranged at upper parts of each micromirror 200-1, 200-2 and . . . 200-10 can correspond to sub cooling units and the sub cooling units can be arranged in a line, to thereby form the cooling unit, which is TEC 600.

It is possible to uniform the temperature of the central micromirrors (e.g. 200-4, 200-5 and 200-6) and the temperature of the bottom micromirrors (e.g. 200-1, 200-10) through the different cooling effect caused by arranging an N or P-type semiconductor having a high doping level in upper parts of the central micromirrors (e.g. 200-4, 200-5 and 200-6) having relatively high temperature.

However, as described with reference to FIG. 4, since the difference in temperature of each micromirror 200-1, 200-2 and . . . 200-10 is equal to or smaller than 0.5□, the doping level can be controlled without big difference. Also, a sub cooling unit having a uniform doping level can be arranged according to the type and design of the micromirrors.

In a display apparatus in accordance with an embodiment of the present invention, it is possible to obtain the temperature uniformity of each micromirror by using different sizes of the TEC 600 instead of the difference of the doping level.

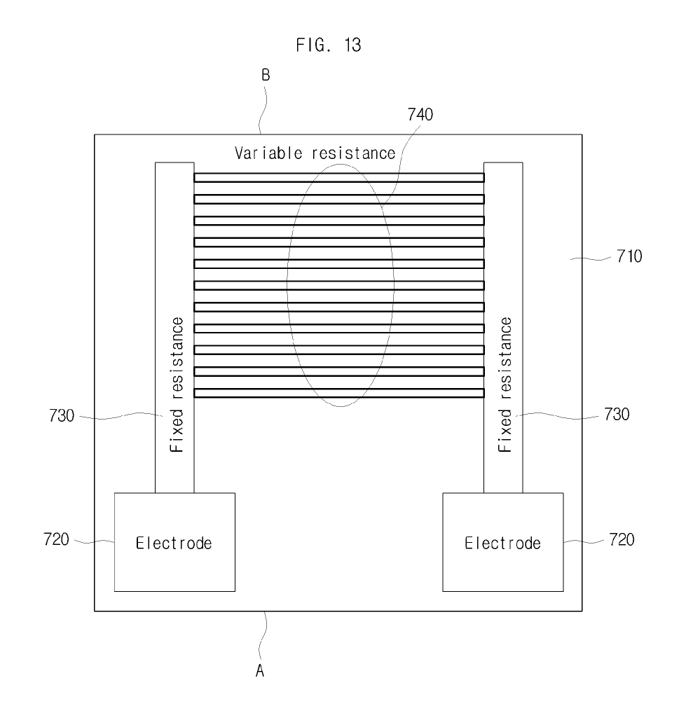

FIG. 11 is a front view showing the structure of an optical modulator module including a heat conductive unit and a cooling unit in accordance with another embodiment of the present invention

Referring to FIG. 11, a heat-conducting unit can be arranged at a point in which the TEC 600 has arranged. This indicates that the cooling reaction is created by allowing the heat generated from the optical modulator 120 to be transferred to the TEC 600 through the heat-conducting not to be directly absorbed by the TEC 600.

In other words, it may be required to discharge the generated heat to the outside because the endothermic reaction and the exothermic reaction may be created together as described with reference to FIG. 9. Accordingly, the TEC 600 can be arranged to penetrate through a connector 900 in order to allow the surface including the contacts creating the exothermic reaction to protrude to the outside.

Accordingly, even though the TEC 600 can actually cool the heat conducting unit, since the heat conducting unit is made of aluminum Al, copper Cu and/or silver Ag having high heat-conductivity, the present invention can have the effect as if the TEC 600 discharges the heat generated by the optical modulator 120 to the outside.

In this case, the heat generated in the inside of the optical modulator 120 can be efficiently discharged to the outside by coupling a separate heat sink (not shown) to the surface of the TEC 600, including the contacts creating the exothermic reaction or by manufacturing the surface of the TEC 600, including the contacts creating the exothermic reaction to have a shape of the heat sink. In the description of the present invention, while the exothermic reaction may be related to the reaction created in the TEC 600 (i.e. a cooling element), the heat-radiating reaction may indicate that the heat is discharged from the inside of the optical modulator module to the outside.

The heat sink can be formed to include a plurality of upright pins having a shape of a typically used surface. Alternatively, the heat sink can be formed to have a protrusion shape in order to widen the area and minimize the contact space with an external terminal. However, the present invention is not limited to these embodiments.

Further, the heat sink can be formed to have a flexible shape such as a plate-type spring in order to the contact stability. In the case of using the heat sink having a plate-type spring shape, the contact status can be stably maintained in spite of the repeated contraction and expansion caused by the repeated heating and cooling.

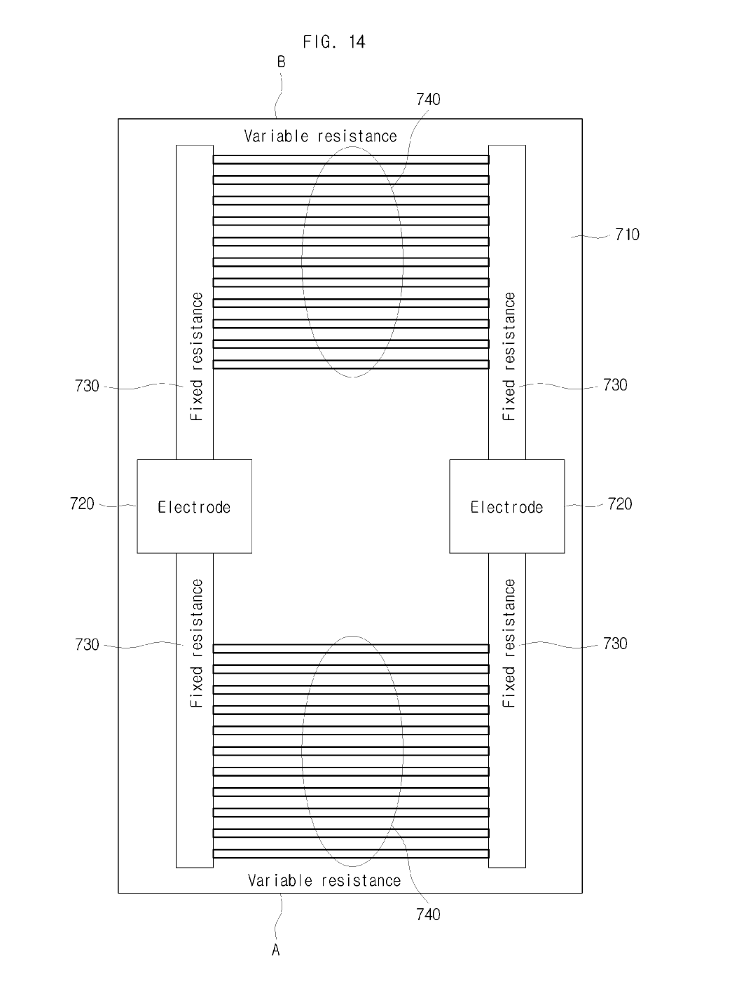

FIG. 12 is a front view showing the structure of an optical modulator module including a heat conductive unit and a cooling unit in accordance with another embodiment of the present invention.

Differently from the structure of the optical modulator module of FIG. 11, the TEC 600 can be arranged in a direction of light output or input in the optical modulator module of FIG. 12.

The heat of the optical modulator 120 can be transferred to the heat conducting unit, described in FIG. 10 before being transferred to the optical substrate 830 through the spacing part 840 made of a metal. The heat transferred to the optical substrate 830 can be discharged to the outside through the TEC 600.

The cooling unit arranged at the optical substrate 830 can include a first TEC 600a and a second TEC 600b in order to discharge the heat of the optical modulator 120. At this time, a heat conducting unit can be placed at an upper part of the optical modulator in order to lower the temperature of the optical modulator 120, for example.

Here, the first TEC 600a and the TEC 600b may be required to be spaced with each other in order to allow a beam of light to be incident, reflected and diffracted without any restriction caused by the gap between the first TEC 600a and the TEC 600b. For example, in case that the optical modulator 120 has the width of 1.5 mm, the gap between the first TEC 600a and the TEC 600b may be required to be equal to or wider than 0.5 mm. However, the width is merely an embodiment of the present invention. The width can be changed according to the thickness of the optical substrate 830 and the size of the optical modulator 120.

About the time when the optical modulator module has completely manufactured, the first TEC 600a and the TEC 600b can be coupled to the optical substrate 830. Also, a relatively fewer limits can be placed on the position and size of the TEC 600, to thereby make it easy to manufacture the optical modulator module.

In this case, the contacts creating the endothermic reaction can be in contact with the optical substrate 830, and the contacts creating the exothermic reaction can be arranged to face the outside in the TEC 600. Also, a heat sink (not shown) helping to discharge heat can be coupled to the contacts creating the exothermic reaction. Alternatively, a material for transferring heat to other elements acting as the heat sink can be coupled to the contacts creating the exothermic reaction. The heat sink can have the same shapes as described with reference to FIG. 11.

In accordance with another embodiment of present invention, as described with reference to FIG. 11, the cooling effect can be maximized by arranging the TEC 600 to penetrate through the connector 800 and by arranging the TEC 600 in the optical substrate 830.

The method of the present invention as described above can be stored in a recorded medium (e.g. CDRom, RAM, ROM, floppy disk, hard disk, magneto-optical disk) having shapes capable of being realized as a program and readable by a computer.

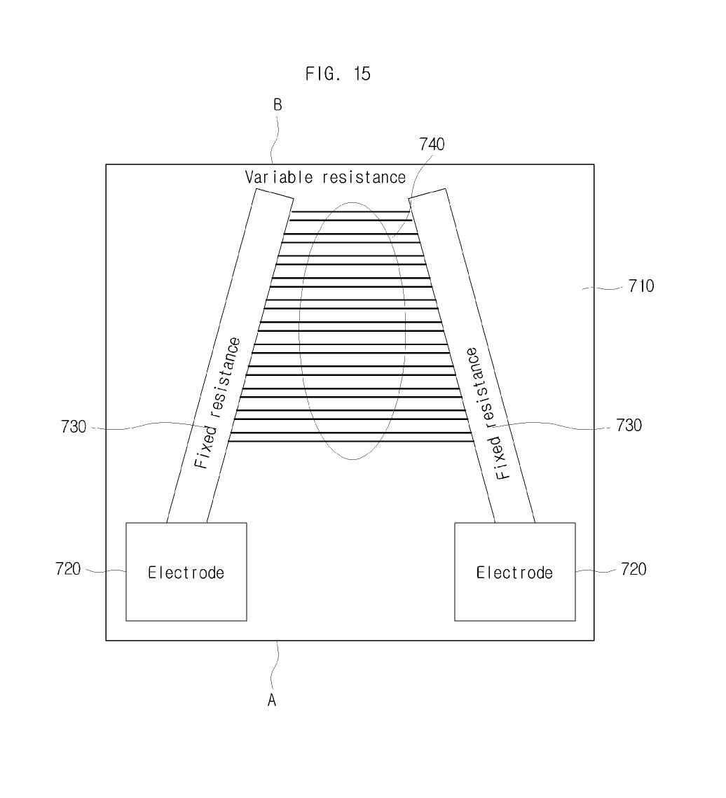

Hereinafter, a temperature sensor capable of performing tuning in accordance with an embodiment of the present invention will be described with reference to FIG. 13. FIG. 13 shows the structure of a temperature sensor that can perform tuning in accordance with an embodiment of the present invention.

Performing the tuning indicates adjusting the resistance precisely in order to allow an initial resistance value of the temperature sensor to be equal to a desired resistance value when the temperature sensor is designed. In accordance with the present invention, performing the tuning indicates severing variable resistances successively. The below description can be the same.

The temperature sensor can include a substrate 710, a plurality of electrodes 720, a fixed resistance 730 and a variable resistance 740. According to the temperature sensor, two electrodes can be placed at an upper part of the substrate 710, with being spaced with each other. Later, it may be possible to measure the resistance between the electrodes 720 connected by using a line through the amount of a current flowing between the electrodes 720 and the voltage between the electrodes 720.

Accordingly, the temperature sensor capable of performing the tuning may be required to include at least two electrodes 720. At this time, the resistance value measured before the tuning is performed can become a value of a total of resistance of the fixed resistance 730 and the variable resistance 740, which is a composite resistance value evaluated by allowing the fixed resistance 730 and the variable resistance 740 to be connected. A basic resistance refers to the composite resistance value. The below description can be the same.

A measured resistance refers to the resistance measured while performing the tuning of the variable resistance 740. At this time, the tuning can be performed with continually checking the measured resistance until the measured resistance reaches to the desired resistance. In the present invention, the desired temperature can be a pre-designed resistance value as an initial resistance value of the temperature sensor. The below description can be the same.

Although it is possible to include a plurality of electrodes 720, the below description with reference to FIG. 13 focuses on the case of including two electrodes 720. Two electrodes 720 can be placed at a side of an upper part of the substrate 710. The electrodes 720 can be connected to the fixed resistances 730 having a shape prolonged to the other side facing the one side in which the electrodes 720 are placed. At this time, the fixed resistances can have any shapes without any restriction of its width and length. The fixed resistances 730, unlike the below-described variable resistances 740, can have an unchangeable value.

Accordingly, the temperature sensor having the same resistance value as the desired resistance by manufacturing the fixed resistance 730 to have the similar desired resistance and by performing the tuning of the variable resistance 740 for a value, insufficient for the basic resistance, which is unable to be precisely adjusted by using the fixed resistance 730. In other words, it is possible to allow the basic resistance to reach to the desired temperature by manufacturing the basic resistance to have a small value than the desired resistance value and by successively severing the variable resistances 740 connected in parallel.

At this time, the fixed resistance 730 and the variable resistance 740 can be made of platinum Pt, gold Au, copper Cu and/or tungsten W. The Pt can be considered as one of most popular materials for the temperature sensor thanks to good accuracy and reproducibility by sensibly reacting to the resistance varied according to the change of temperature.

On the substrate 710, a plurality of variable resistances 740 can be connected in parallel between the fixed resistances connected to the electrodes 720. At this time, the number of the variable resistances 740 may not be fixed. At least one variable resistance can have a different width from those of the other variable resistances 740. Here, in the variable resistance 740, its width may have a close relationship with its resistance. As such, the variety of the number and width of the variable resistance 740 makes it possible to more precisely perform the tuning of the temperature sensor.

Until the basic resistance reach to the desired resistance while continually keeping the resistance computed, through the current flowing through the two electrodes 720 and the voltage between the two electrodes 720, observed, if the amount of the current flowing through the two electrodes 720 or the voltage between the two electrodes 720 is increased, the variable resistances 740 may be severed successively from the variable resistance having the smallest width.

As such, allowing the variable resistances 740 to be severed one by one can cause the effect that the resistances connected in parallel between the fixed resistances 730 are severed, to thereby increase the resistance value. If the basic resistance reaches to the desired resistance, it may be required to stop raising the amount of the current or the voltage in order to prevent the variable resistances from being severed. In other words, it is possible to manufacture the temperature sensor having the identical or similar resistance to the desired resistance by manufacturing the basic resistance to have a small value than the desired resistance value and by successively severing the variable resistances 740 connected in parallel.

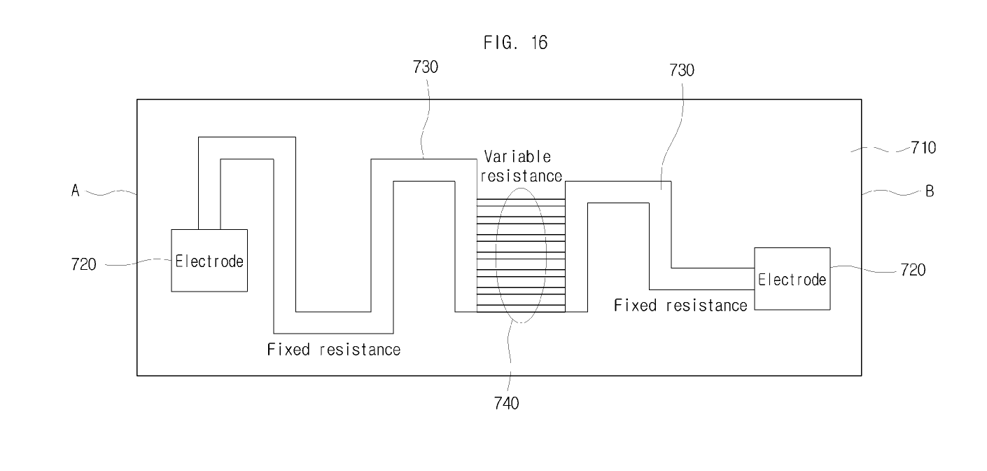

Hereinafter, a temperature sensor capable of performing tuning in other embodiments of the present invention will be described with reference to FIG. 14 through FIG. 16. FIG. 14, FIG. 15 and FIG. 16 show each structure of temperature sensors that can perform tuning in accordance with various embodiments of the present invention.

Since the temperature sensor in accordance with each different embodiment has the same basic structure as described with reference to FIG. 13, the pertinent overlapped description will be omitted for the convenience of understanding and description of the present invention.

Firstly, referring to FIG. 14, two electrodes 720 can be placed on the substrate 710. At this time, at least two electrodes may be required to be placed as described above. A total of 4 fixed resistances 730 can be connected to the electrodes 720. Each fixed resistances connected to the electrodes 720 can be formed to have shapes extended in a lengthwise direction of one side A or the other side B. In particular, one electrode 720 can have one side, which is connected to one fixed resistance 730 extended in the lengthwise direction of the one side A, and the other side, which is connected to another fixed resistance 730 extended in the lengthwise direction of the other side B.

A plurality of variable resistances 740 can be connected between the fixed resistances 730 in parallel. Accordingly, the basic resistance having a resistance value which is designed to be smaller than the desired resistance can gradually approach to the desired resistance by successively severing the variable resistances 740.

Next to FIG. 15, which has a similar structure to FIG. 13, the different point from FIG. 13 is that the fixed resistances can be connected to the electrodes 720 with extending to the other side to have an inclined shape not a vertical shape. At this time, although the plurality of variable resistances connecting the fixed resistances 730 have the same widths, since the inclination of the fixed resistances 730 causes each length of the variable resistances 740 to be different from each other. Accordingly, each variable resistance 740 can have different values.

Finally, referring to FIG. 16, two electrodes can be placed on the substrate 710. The fixed resistance 730 connected to one electrode 720 placed at one side A can be extended toward the other side B in a zigzag shape. Inversely, the fixed resistance 730 connected to one electrode placed at the other side B can be extended toward the one side A in a zigzag shape. A plurality of variable resistances 740 can be connected between the fixed resistances 730 extended to the one side A and the fixed resistance 730 extended to the other side B. At this time, the plurality of variable resistances 740 can be connected in parallel. Accordingly, it is possible to perform tuning by successively severing the variable resistances in order to allow the basic resistance to approach to the desired resistance in a predetermined range capable of recognizing that the basic resistance is identical to the desired resistance.

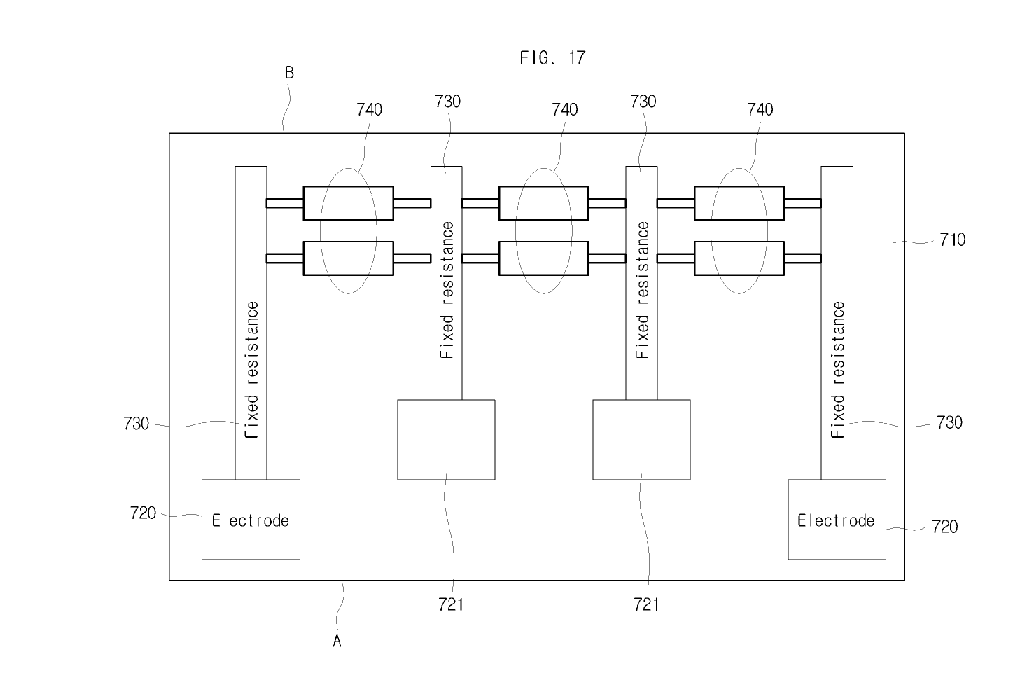

Hereinafter, the structure of a temperature sensor capable of performing tuning in accordance with another embodiment of the present invention will be described with reference to FIG. 17. FIG. 17 shows the structure of a temperature sensor that can perform tuning in accordance with another embodiment of the present invention.

Since the basic temperature sensor tuning method and the corresponding structure are the same as described with reference to FIG. 13, the pertinent overlapped description will be omitted for the convenience of understanding and description of the present invention.

In accordance with another embodiment of the present invention, the temperature sensor can include a substrate 710, an electrode 720, a fixed resistance 730, a variable resistance 740 and a tuning electrode 721. A plurality of electrodes 720 can be placed at an upper part of the substrate 710. In accordance with another embodiment of the present invention related to FIG. 17, two tuning electrodes 721 as well as the two electrodes 720 can be placed at the upper part of the substrate 710. The tuning electrodes 721 can be used as a temporary electrode in order to perform the tuning of the variable resistances 740 by severing various groups into which the variable resistances are divided per group.

At one side A of the substrate 710, the electrodes 720 and 721 can have each same side, which is connected to the fixed resistance 730 extended in a direction of the other side B opposite to the one side A. Between the fixed resistances 730, the variable resistances 740 can be connected in parallel vertically to the lengthwise direction of the fixed resistance 730. As described above, the basic resistance can be designed to have a smaller resistance than the desired resistance.

The variable resistances 740 connected in parallel can be successively severed as a current flowing through the electrodes 720 or a voltage between the electrodes 720 is gradually increased. This may result in the increase of the resistance, to thereby perform the tuning in order to allow the basic temperature to approach to the desired resistance of the temperature sensor in a predetermined range capable of recognizing that the basic resistance is identical to the desired resistance. The method and principle of the tuning is the same as described with reference to FIG. 13.

Conventionally, the composite resistance of all connected resistances of FIG. 17, which is the basic resistance, is required to be equal to an initial resistance of the temperature sensor. However, in the case of the temperature sensor capable of performing tuning in accordance with another embodiment of the present invention, the desired initial resistance of the temperature sensor can become the desired resistance, and the resistance measured while performing the tuning of the variable resistances 740 can become the measured resistance.

The below description related to the desired resistance and the measured resistance can apply to the same. In accordance with the present invention, if the measured resistance approaches to the desired resistance in a predetermined range in the continual comparison of the desired resistance and the measured resistance, the tuning may be stopped. At this time, the measured resistance can be considered as the initial resistance of the temperature sensor.

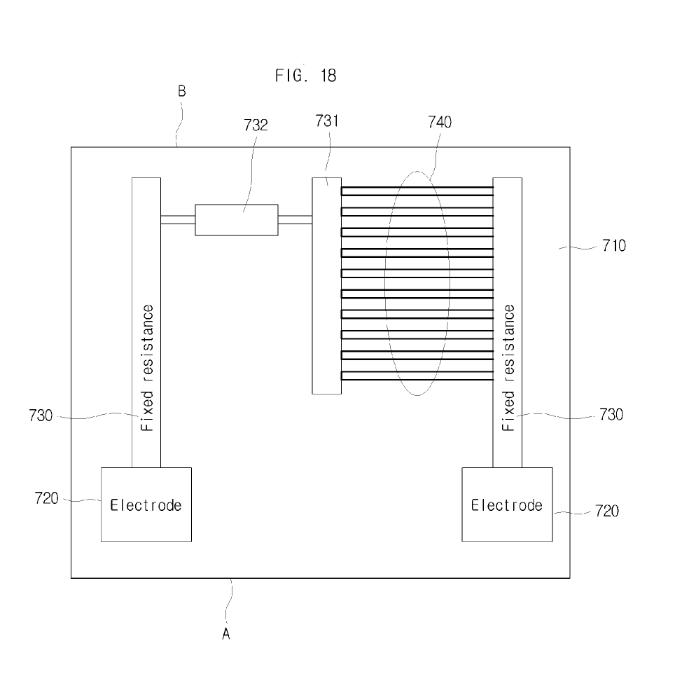

Hereinafter, the structure of a temperature sensor capable of performing tuning in accordance with another embodiment of the present invention will be described with reference to FIG. 18. FIG. 18 shows the structure of a temperature sensor that can perform tuning in accordance with another embodiment of the present invention.

Two electrodes 720 can be placed at an upper part of the substrate 710. At one side A of the substrate 710, the fixed resistance 730 (or called as a contact fixed resistance) extended in a direction of the other side B opposite to the one side A can be connected to the electrode 720. A noncontact fixed resistance 731 extended in the direction of the other side B can be placed between the fixed resistances with being in noncontact with the electrode 720. A bridge fixed resistance 732 can be connected between the noncontact fixed resistance and one of the fixed resistances 730 connected to the electrodes 720. At this time, the number of the noncontact fixed resistances is obviously not limited to one.

A plurality of variable resistances 740 can be connected between the noncontact fixed resistance and the other of the fixed resistances 730, which is not connected to the bridge fixed resistance 732. At least one of the variable resistances 740 can have a different width from those of the other variable resistance 740. The width can be much narrower than that of the bridge fixed resistance 732.

Accordingly, it is possible to allow the initial resistance value of the temperature sensor to approach to the desired resistance by supplying a voltage between the two electrodes 720 and flowing a current to measure the resistance and then severing the variable resistances 740 successively from the variable resistance having the narrowest width by raising the amount of the current flowing through the variable resistances 740 in order to perform the tuning of the temperature sensor to be close to the desired resistance.

At this time, as desired above, the fixed resistances 730, 731 and 732 can be designed to allow the basic resistance to have a similar to but minutely smaller than the desired resistance and the minute difference between the basic resistance and the desired resistance can be designed to be adjusted through the variable resistance 740.

For example, in case that the desired resistance is 2.3KΩ, the fixed resistances 730, 731 and 732 can be designed to have 2KΩ. Then, the variable resistances can be designed to have 300%. Accordingly, it is possible to manufacture the temperature sensor having the initial resistance that is identical to the desired temperature of 2.3KΩ by successively severing the variable resistances 740 of 300% until the basic resistance to approach to the desired resistance of 2.3KΩ in a predetermined range.

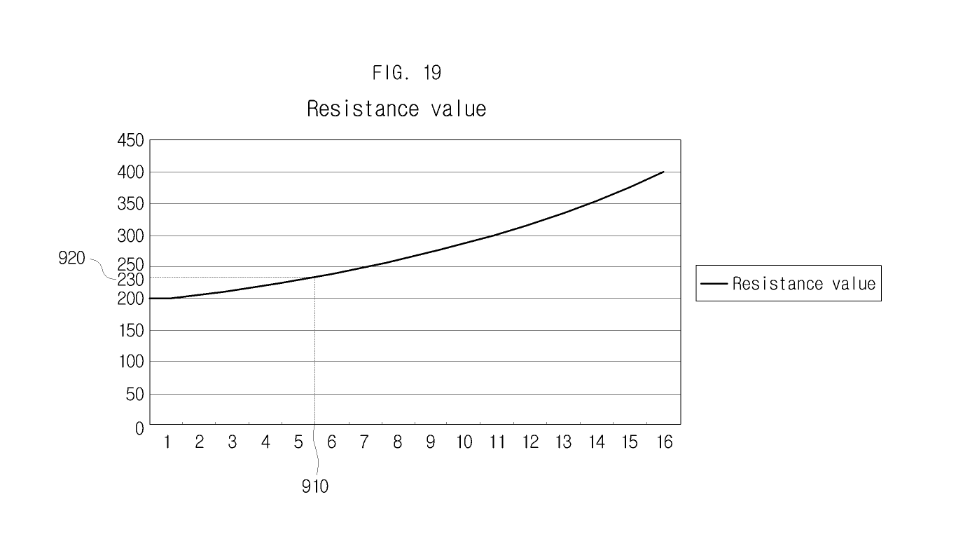

Hereinafter, the change of the resistance caused by a temperature sensor tuning operation will be described with reference to FIG. 19. FIG. 19 is a graph showing the change of resistance when the temperature of FIG. 18 performs tuning.

The horizontal axis of the graph can indicate the number of the severed variable resistances 740 or how many times the tuning is performed, and the vertical axis can indicate the measured resistance. The unit is 10Ω. When the horizontal axis has the value of ‘0’, which no tuning is performed, the measured resistance has the value of 2KΩ. The graph of FIG. 19 shows that the resistance value can be increased as the tuning is performed or the variable resistances 740 are successively severed. This is because severing the resistances connected in parallel can cause the composite resistance to be increased.

If the resistances R1, R2 and R3 are connected in series, the relationship between the composite resistance R and the resistances R1, R2 and R3 can be represented as the following formula 4.

R=R1+R2+R3 [Formula 4]

If the resistances R1, R2 and R3 are connected in parallel, the relationship between the composite resistance R and the resistances R1, R2 and R3 can be represented as the following formula 4.

$$\frac{1}{R} = \frac{1}{R 1} + \frac{1}{R 2} + \frac{1}{R 3} \qquad [ Formula 5 ]$$

Accordingly, if some of the parallel-connected resistances are missed, the composite resistance is increased.

According to the graph of FIG. 19, in case that the desired resistance is 2.3KΩ, when the vertical axis points 2.3KΩ 920, the horizontal axis points 5 times 910. This shows that severing 5 variable resistances makes it possible to manufacture a temperature sensor having the initial resistance value of 2.3KΩ, which is the same as the desired resistance.

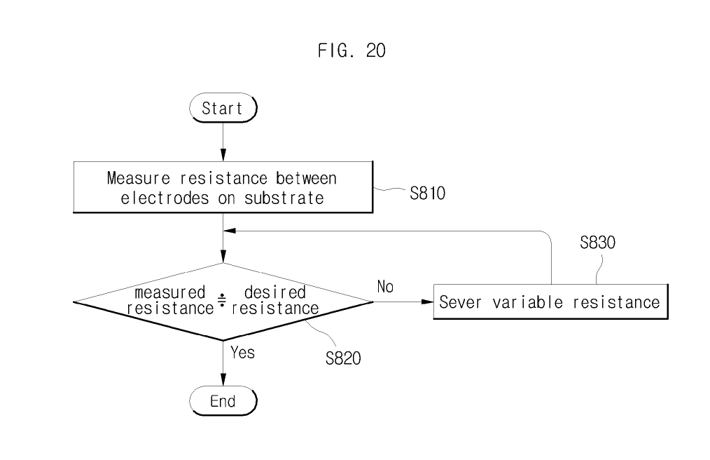

Hereinafter, the temperature sensor tuning method in accordance with the present invention will be described with reference to FIG. 20. FIG. 20 is a flow chart showing a temperature sensor tuning method in accordance with an embodiment of the present invention.

At this time, the pertinent overlapped description will be omitted for the convenience of understanding and description of the present invention.

A step represented by S810 can measure a voltage between electrodes placed on a substrate and a current flowing through the electrodes before measuring a resistance by using the Ohm's law in order to perform the tuning of the temperature sensor. A basic resistance refers to the composite resistance value of a fixed resistance and a variable resistance placed on the substrate in the beginning before the tuning is performed. At this time, the basic resistance can be set to have a smaller resistance value than the desired resistance. A measured resistance refers to the resistance measured while performing the tuning of the variable resistance. A step represented by S820 can determine whether the measured resistance is identical to the desired resistance by comparing the two resistances. Determining whether the measured resistance is identical to the desired resistance can be performed by checking whether the difference between the two resistances is within a predetermined threshold.

If the difference between the two resistances is not within the predetermined threshold, a step represented by S830 can sever the variable resistances connected in parallel. Then, the process can return to the step represented by S820. Theses repeated steps can be performed until the difference between the two resistances is within the predetermined threshold.

At this time, severing the variable resistance can be performed by increasing the current or the voltage. Through the above steps, the temperature sensor having the initial resistance which is identical to the desired temperature can be manufactured in order to more accurately measure the temperature.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents

What is claimed is:

1. An optical modulator module, comprising:
an optical modulator, modulating a beam of light emitted from a light source and emitting the modulated beam of light; and
a micro-heater, manufactured in the optical modulator.

2. The optical modulator module of claim 1, wherein a line of a micro-heater is formed close to an edge of the micro-heater along an inside of the edge.

3. The optical modulator module of claim 1, wherein the micro-heater is manufactured on a surface on which a mirror of the optical modulator.

4. The optical modulator module of claim 1, wherein the micro-heater is manufactured on a surface opposite to a surface on which a mirror of the optical modulator.

5. The optical modulator module of claim 1, wherein a line of a micro-heater is formed to have a zigzag shape on the micro-heater.

6. The optical modulator module of claim 1, wherein the micro-heater is made of any one of a copper thin film and a platinum thin film.

7. The optical modulator module of claim 1, wherein the micro-heater controls a temperature of the optical modulator according to a driving by on/off of a power of the micro-heater.

8. The optical modulator module of claim 1, wherein the micro-heater controls a temperature of the optical modulator according to a current flowing through the micro-heater.

9. The optical modulator module of claim 1, further comprising: a temperature sensor measuring a temperature of the optical modulator.

10. The optical modulator module of claim 9, wherein the temperature sensor is any one of a resistance temperature detector (RTD) temperature sensor and a thermistor.

11. The optical modulator module of claim 10, wherein the RTD temperature sensor is made of any one of copper and platinum.

12. The optical modulator module of claim 1, wherein the optical modulator is any one of a reflective type, a transmissive type and a diffractive type.

13. An optical modulator module, comprising:
an optical modulator, having one surface formed with a mirror surface receiving a beam of light and modulating the receive beam of light before outputting the modulated beam of light; and
a cooling unit, being in touch with another surface of the optical modulator or arranged at a point, vertically spaced with another surface of the optical modulator at a predetermined distance.

14. The optical modulator module of claim 13, wherein the cooling unit is a thermoelectric cooler using the Peltier effect.

15. The optical modulator module of claim 13, wherein the optical modulator further comprises a spacing part forming a spacing space in a vertical direction from another surface of the optical modulator,
whereas the cooling unit is arranged in the spacing space.

16. The optical modulator module of claim 15, wherein a temperature sensor is arranged at a different point from the point at which the cooling unit is arranged in the spacing space.

17. The optical modulator module of claim 16, wherein the temperature sensor is any one of a resistance temperature detector (RTD) temperature sensor and a thermistor.

18. The optical modulator module of claim 16, wherein the cooling unit is a thermoelectric cooler using the Peltier effect, and the optical modulator module further comprises a control circuit controlling a current flowing through the cooling unit according to a temperature measured by the temperature sensor.

19. The optical modulator module of claim 18, wherein the control circuit controls a direction of a current flowing through the cooling unit in case that the temperature measured by the temperature sensor is equal to or higher than a predetermined operation threshold to be opposite to a direction of the current flowing through the cooling unit in case that the temperature measured by the temperature sensor is lower than the predetermined operation threshold.

20. The optical modulator module of claim 13, wherein the optical modulator is formed with a plurality of micromirrors arranged in a line, and
the cooling unit is formed to include a plurality of sub cooling units arranged on another surface corresponding to each of the plurality of micromirrors.

21. The optical modulator module of claim 20, wherein the plurality of sub cooling units has a contact size changed according to each position of the micromirrors.

22. The optical modulator module of claim 20, wherein the cooling unit is a thermoelectric cooler using the Peltier effect, and
the sub cooling unit is formed to include a semiconductor that is doped with a different doping level according to each position of the micromirrors.

23. The optical modulator module of claim 13, wherein the optical modulator is any one of a reflective type, a transmissive type and a diffractive type.

24. An optical modulator module, comprising:
an optical modulator, having one surface formed with a mirror surface receiving a beam of light and modulating the receive beam of light before outputting the modulated beam of light;
a spacing part, made of a metal and forming a spacing space in a vertical direction from another surface of the present invention;
a heat conducting unit, arranged at the spaced space and absorbing a heat from the optical modulator; and
a cooling unit, arranged at a surface opposite to a surface in which the heat conducting unit is arranged.

25. The optical modulator module of claim 24, wherein the cooling unit is a thermoelectric cooler using the Peltier effect.

26. An optical modulator module, comprising:
an optical modulator, having one surface formed with a mirror surface receiving a beam of light and modulating the receive beam of light before outputting the modulated beam of light;
a spacing part, made of a metal and forming a spacing space in a vertical direction from another surface of the present invention;
a heat conducting unit, arranged at the spaced space and absorbing a heat from the optical modulator;
an optical substrate, being in contact with the one surface of the optical modulator; and
a cooling unit, arranged at a surface opposite to a surface in which the heat conducting unit is arranged.

27. The optical modulator module of claim 26, wherein the cooling unit comprises a heat sink formed at a side opposite to the optical substrate.

28. The optical modulator module of claim 26, wherein the cooling unit is formed to include a first cooling unit and a second cooling unit, and
the first cooling unit and the second cooling unit are spaced from each other to have a space therebetween capable of allowing a beam of light to be incident and a modulation beam of light, modulated by the optical modulator, to be outputted through the optical substrate.

29. The optical modulator module of claim 26, wherein the optical modulator is any one of a reflective type, a transmissive type and a diffractive type.

30. An optical modulator cooling method using a thermoelectric cooler (TEC) included in an optical modulator module, the method comprising:
allowing a temperature sensor included in the optical modulator module to measure a temperature of an inside of an optical modulator;
allowing a control circuit included in the optical modulator module to control a direction of a current flowing through the TEC in case that the temperature measured by the temperature sensor is equal to or higher than a predetermined operation threshold to be opposite to a direction of the current flowing through the TEC in case that the temperature measured by the temperature sensor is lower than the predetermined operation threshold.; and
allowing the TEC to absorb or discharge the heat of the optical modulator according to a control of the control circuit.

31. The method of claim 30, wherein the optical modulator is any one of a reflective type, a transmissive type and a diffractive type.

32. A recorded medium recorded with a program of instructions executable by a thermoelectric cooler (TEC) included in an optical modulator module to execute a method for cooling an optical modulator included in the optical modulator module, the program comprising:
allowing a temperature sensor included in the optical modulator module to measure a temperature of an inside of an optical modulator;
allowing a control circuit included in the optical modulator module to control a direction of a current flowing through the TEC in case that the temperature measured by the temperature sensor is equal to or higher than a predetermined operation threshold to be opposite to a direction of the current flowing through the TEC in case that the temperature measured by the temperature sensor is lower than the predetermined operation threshold; and
allowing the TEC to absorb or discharge the heat of the optical modulator according to a control of the control circuit.

33. The recorded medium of claim 32, wherein the optical modulator is any one of a reflective type, a transmissive type and a diffractive type.

34. A temperature sensor, comprising:
a substrate;
a plurality of electrodes, arranged on the substrate;
a plurality of fixed resistances, having an end part connected to each of the electrodes and connected to each other; and
a plurality of variable resistances, connected in parallel and successively severed according to a current flowing between the electrodes.

35. The temperature sensor of claim 34, wherein the fixed resistance comprises
a contact fixed resistance, having one end part connected to the electrode;
a noncontact fixed resistance, disconnected to the electrode; and
a bridge fixed resistance, connecting the contact fixed resistance and the noncontact fixed resistance.

36. The temperature sensor of claim 34, wherein a thermistor, a resistance temperature detector (RTD or both are used for the fixed resistance and the variable resistance.

37. The temperature sensor of claim 34, wherein at least one of the plurality of variable resistances has a different width from those of the other variable resistances.

38. The temperature sensor of claim 34, wherein the plurality of variable resistances are connected between the fixed resistances to have a small basic resistance than a desired resistance, and
the basic resistance refers to a composite resistance of the variable resistances and the fixed resistances before the variable resistances are severed.

39. The temperature sensor of claim 34, wherein the fixed resistance and the variable resistance is made of platinum Pt, gold Au, copper Cu and/or tungsten W.

40. The temperature sensor of claim 34, wherein the temperature sensor is applicable to any one of a reflective type, a transmissive type and a diffractive type of the optical modulator.

41. A temperature sensor tuning method, comprising:
placing a plurality of electrodes on a substrate;
connecting a plurality of fixed resistances in one surface of the electrode or an upper part of the substrate;
placing a plurality of variable resistances connecting between the fixed resistances; and
severing connection between the plurality of variable resistances and the fixed resistances according to a desired resistance.

42. The method of claim 41, wherein the step of severing connection between the plurality of variable resistances and the fixed resistances comprises
measuring a resistance value between the electrodes arranged on the substrate;
comparing the measured resistance value with a desired resistance;
severing any one of the plurality of variable resistances connecting the fixed resistances if a difference between the measured resistance value and the desired resistance is beyond a range capable of considering that the measured resistance value is identical to the desired resistance.

43. The method of claim 41, wherein the step of severing any one of the plurality of variable resistances connecting the fixed resistances is executed by successively severing the plurality of variable resistances through raising a current flowing through the electrodes or a voltage between the electrodes.

44. The method of claim 41, wherein determining whether the difference between the measured resistance value and the desired resistance is within the range capable of considering that the measured resistance value is identical to the desired resistance is performed by determining whether the difference between the measured resistance value and the desired resistance is within a predetermined threshold.
